(19) United States
(12) Patent Application Publication
(10) Pub. No.: US 2024/0054121 A1
(43) Pub. Date: Feb. 15, 2024

(54) DATA CHARACTERISTICS ASSOCIATED WITH TYPICAL METADATA

(71) Applicant: Ancestry.com DNA, LLC, Lehi, UT (US)

(72) Inventors: David Andrew Turissini, San Francisco, CA (US); Yong Wang, San Mateo, CA (US)

(21) Appl. No.: 18/234,037

(22) Filed: Aug. 15, 2023

Related U.S. Application Data
(60) Provisional application No. 63/397,946, filed on Aug. 15, 2022.

(51) Int. Cl. G06F 16/22; G06F 16/28

(52) U.S. Cl. CPC G06F 16/2246; G06F 16/288; G06F 16/287

(57) ABSTRACT

A computing server may scan through a named-entity data store to identify a plurality of candidate named-entity data instances. The computing server may identify one or more upper-level nodes in the corresponding data tree where the named entity is represented as a node. The computing server may determine, for each candidate named-entity data instance associated with the corresponding data tree, geographical location tags of the one or more upper-level nodes. The computing server may determine, based on the geographical location tags, the candidate named-entity data instance is a named-entity data instance typically associated with a geographical location. The computing server may identify a plurality of named-entity data instances that are typically associated with the geographical location. The computing server may aggregate data characteristics of the named-entity data instances that are typically associated with the geographical location. The computing server may display an aggregated characteristic associated with the geographical location.

### CROSS-REFERENCE TO RELATED APPLICATION

The present application claims the benefit of U.S. Provisional Patent Application No. 63/397,946, filed on Aug. 15, 2022, which is hereby incorporated by reference in its entirety.

### FIELD

The disclosed embodiments relate to methods, systems, and computer-program products for determining data characteristics of data instances that are typically associated with a specific type of metadata.

### BACKGROUND

A large-scale database such as a genealogy database can include billions of data records. This type of database may allow users to build family trees, research their family history, and make meaningful discoveries about the lives of their ancestors. Users may try to identify relatives with datasets in the database. However, identifying relatives in the sheer amount of data is not a trivial task. Datasets associated with different individuals may not be connected without a proper determination of how the datasets are related. Comparing a large number of datasets without a concrete strategy may also be computationally infeasible because each dataset may also include a large number of data bits. Given an individual dataset and a database with datasets that are potentially related to the individual dataset, it is often challenging to identify a dataset in the database that is associated with the individual dataset.

### SUMMARY

Disclosed herein relates to example embodiments that are related to a computer-implemented method, including: scanning through a named-entity data store to identify a plurality of candidate named-entity data instances, wherein at least a majority of the candidate named-entity data instances correspond to named entities that are each associated with a data tree; identifying, for each candidate named-entity data instance associated with a corresponding data tree, one or more upper-level nodes in the corresponding data tree where the named entity is represented as a node, wherein an upper-level node is positioned higher than the node representing the named entity; determining, for each candidate named-entity data instance associated with the corresponding data tree, geographical location tags of the one or more upper-level nodes; determining, based on the geographical location tags, the candidate named-entity data instance is a named-entity data instance typically associated with a geographical location; identifying a plurality of named-entity data instances that are typically associated with the geographical location; aggregating data characteristics of the plurality of named-entity data instances that are typically associated with the geographical location; and causing to display aggregated characteristics associated with the geographical location based on aggregating the data characteristics of the plurality of named-entity data instances.

In some embodiments, the one or more upper-level nodes in the corresponding data tree of a particular candidate named-entity data instance are terminal nodes.

In some embodiments, the one or more upper-level nodes in the corresponding data tree of a particular candidate named-entity data instance separate from the named entity for at least two levels in the data tree.

In some embodiments, determining a particular candidate named-entity data instance is a named-entity data instance typically associated with the geographical location includes: determining the geographical location tags of each of the one or more upper-level nodes; determining that the geographical location tags all correspond to a same particular geographical location; and determining that the particular candidate named-entity data instance is typically associated with the particular geographical location.

In some embodiments, the computer-implemented method may further include: adding the plurality of named-entity data instances that are typically associated with the geographical location as a reference panel of the geographical location.

In some embodiments, the data characteristics of the plurality of named-entity data instances include sequence compositions of the named-entity data instances.

In some embodiments, displaying the aggregated characteristics associated with the geographical location includes displaying a distribution of one or more aggregated characteristics.

In some embodiments, the data characteristics of each of the plurality of named-entity data instances are determined based on: inputting a sequence in the named-entity data instance to a hidden Markov model; and generating a composition of the sequence using the hidden Markov model, wherein the composition of the sequence is the data characteristics.

In some embodiments, a non-transitory computer-readable medium that is configured to store instructions is described. The instructions, when executed by one or more processors, cause the one or more processors to perform a process that includes steps described in the above computer-implemented methods or described in any embodiments of this disclosure. In some embodiments, a system may include one or more processors and a storage medium that is configured to store instructions. The instructions, when executed by one or more processors, cause the one or more processors to perform a process that includes steps described in the above computer-implemented methods or described in any embodiments of this disclosure.

### BRIEF DESCRIPTION OF THE DRAWINGS

Figure (FIG. 1 illustrates a diagram of a system environment of an example computing system, in accordance with some embodiments.

FIG. 2 is a block diagram of an architecture of an example computing system, in accordance with some embodiments.

FIG. 3A is a flowchart depicting an example process for extracting characteristics of a set of representative data instances that are typically associated with a geographical location, in accordance with some embodiments.

FIG. 3B is a conceptual diagram illustrating a data tree, in accordance with some embodiments.

FIGS. 4A-4E show graphs of a typical Danish user's ethnicity estimate attributable to particular countries, in accordance with some embodiments.

FIG. 5 is a graph of a typical Italian user's ethnicity estimate attributable to particular countries, in accordance with some embodiments.

FIG. 6 is a graph of a typical English user's ethnicity estimate attributable to particular countries, in accordance with some embodiments.

FIGS. 7A-7E are diagrams of an alternative embodiment for determining a typical native, in accordance with some embodiments.

FIGS. 8A and 8B are corresponding diagrams showing a profile and heatmap generated to illustrate a typical native, in accordance with some embodiments.

FIG. 9 is a block diagram of an example computing device, in accordance with some embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Single-origin customers of a genetic and/or genealogical research service who have deep roots from the same areas (e.g., countries) often do not see a 100% ethnicity-estimate assignment to their country or area of origin despite knowing that they have deep roots in that country. For example, a customer from southern France, and who has deep family roots extending back many generations in southern France, can expect to see only ˜70% French ethnicity in their ethnicity results. This is because genetic variation is shared across populations reflecting deep histories of human admixture and migration stretching back tens of thousands of years. Genetic variation, though shared, is often more or less common in different places serving as the basis for ethnicity estimates.

This can be confusing, and users are more likely to assume that the estimate or technology is flawed (at least in their case) than to assume that there are nuances to a typical French person's genetic heritage, such as an estimate that includes approximately 30% of non-French ethnicity. Further, not everyone from France is the same, and may have a range of non-French ethnicity in their estimate. This can lead users to erroneously interpret averages as expected values for everyone from a certain place.

As another example, a customer with family roots in southwest England that extend back three to nine generations may receive an ethnicity estimate as follows: “70% England & Northwestern Europe; 24% Scotland; 3% Germanic Europe; 2% Wales.” This can be very confusing if they know based on established and reliable family trees that they do not have any significant ancestry from Scotland to explain the 24% Scotland estimate. A user may question their family history (e.g., suspect an affair somewhere in their recent family history) or, more likely, doubt the accuracy of the DNA estimate. Users are unlikely to assume the more-likely explanation that people with deep roots in England, i.e. typical natives of England, tend to be associated with substantial amounts of other ethnicities', particularly nearby ethnicities', DNA. This is often due to extensive shared histories between adjacent ethnic groups.

Indeed, users often assume that regions (e.g., England & Northwestern Europe, Scotland) in their ethnicity estimate refers to places, when in fact it really refers to people in the ethnicity reference panel with roots from those places going back many generations. Regions are connected to multiple ethnicities and ethnicities are from multiple places. For instance, some genetic genealogy research services have a plurality of regions (e.g., 70) in their ethnicity reference panel, when there are thousands of ethnicities in the world.

It is hard to predict ethnicity estimates for an ethnicity group, as modern labels fail to capture a group's history or their shared histories with other, often adjacent, groups. In view of the foregoing, there is a need for improvements.

A method, system, or computer-program product for determining a typical-native ethnicity includes one or more of the following: providing a database of users, filtering the users to identify users with associated DNA data, identifying a pedigree associated with the identified DNA users, tracing the pedigree to identify a plurality of terminals and retrieve associated metadata, assigning certain of the users to a typical-native reference panel for a particular location based on the retrieved metadata, and determining an ethnicity for a typical native based on the typical-native reference panel for the location.

### Example System Environment

FIG. 1 illustrates a diagram of a system environment 100 of an example computing server 130, in accordance with some embodiments. The system environment 100 shown in FIG. 1 includes one or more client devices 110, a network 120, a genetic data extraction service server 125, and a computing server 130. In various embodiments, the system environment 100 may include fewer or additional components. The system environment 100 may also include different components.

The client devices 110 are one or more computing devices capable of receiving user input as well as transmitting and/or receiving data via a network 120. Example computing devices include desktop computers, laptop computers, personal digital assistants (PDAs), smartphones, tablets, wearable electronic devices (e.g., smartwatches), smart household appliances (e.g., smart televisions, smart speakers, smart home hubs), Internet of Things (IoT) devices or other suitable electronic devices. A client device 110 communicates to other components via the network 120. Users may be customers of the computing server 130 or any individuals who access the system of the computing server 130, such as an online website or a mobile application. In some embodiments, a client device 110 executes an application that launches a graphical user interface (GUI) for a user of the client device 110 to interact with the computing server 130. The GUI may be an example of a user interface 115. A client device 110 may also execute a web browser application to enable interactions between the client device 110 and the computing server 130 via the network 120. In another embodiment, the user interface 115 may take the form of a software application published by the computing server 130 and installed on the user device 110. In yet another embodiment, a client device 110 interacts with the computing server 130 through an application programming interface (API) running on a native operating system of the client device 110, such as IOS or ANDROID.

The network 120 provides connections to the components of the system environment 100 through one or more sub-networks, which may include any combination of local area and/or wide area networks, using both wired and/or wireless communication systems. In some embodiments, a network 120 uses standard communications technologies and/or protocols. For example, a network 120 may include communication links using technologies such as Ethernet, 802.11, worldwide interoperability for microwave access (WiMAX), 3G, 4G, Long Term Evolution (LTE), 5G, code division multiple access (CDMA), digital subscriber line (DSL), etc. Examples of network protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over a network 120 may be represented using any suitable format, such as hypertext markup language (HTML) or extensible markup language (XML). In some embodiments, all or some of the communication links of a network 120 may be encrypted using any suitable technique or techniques such as secure sockets layer (SSL), transport layer security (TLS), virtual private networks (VPNs), Internet Protocol security (IPsec), etc. The network 120 also includes links and packet switching networks such as the Internet.

Individuals, who may be customers of a company operating the computing server 130, provide biological samples for analysis of their genetic data. Individuals may also be referred to as users. In some embodiments, an individual uses a sample collection kit to provide a biological sample (e.g., saliva, blood, hair, tissue) from which genetic data is extracted and determined according to nucleotide processing techniques such as amplification and sequencing. Amplification may include using polymerase chain reaction (PCR) to amplify segments of nucleotide samples. Sequencing may include sequencing of deoxyribonucleic acid (DNA) sequencing, ribonucleic acid (RNA) sequencing, etc. Suitable sequencing techniques may include Sanger sequencing and massively parallel sequencing such as various next-generation sequencing (NGS) techniques including whole genome sequencing, pyrosequencing, sequencing by synthesis, sequencing by ligation, and ion semiconductor sequencing. In some embodiments, a set of SNPs (e.g., 300,000) that are shared between different array platforms (e.g., Illumina OmniExpress Platform and Illumina HumanHap 650Y Platform) may be obtained as genetic data. Genetic data extraction service server 125 receives biological samples from users of the computing server 130. The genetic data extraction service server 125 performs sequencing of the biological samples and determines the base pair sequences of the individuals. The genetic data extraction service server 125 generates the genetic data of the individuals based on the sequencing results. The genetic data may include data sequenced from DNA or RNA and may include base pairs from coding and/or noncoding regions of DNA.

The genetic data may take different forms and include information regarding various biomarkers of an individual. For example, in some embodiments, the genetic data may be the base pair sequence of an individual. The base pair sequence may include the whole genome or a part of the genome such as certain genetic loci of interest. In another embodiment, the genetic data extraction service server 125 may determine genotypes from sequencing results, for example by identifying genotype values of single nucleotide polymorphisms (SNPs) present within the DNA. The results in this example may include a sequence of genotypes corresponding to various SNP sites. A SNP site may also be referred to as a SNP loci. A genetic locus is a segment of a genetic sequence. A locus can be a single site or a longer stretch. The segment can be a single base long or multiple bases long. In some embodiments, the genetic data extraction service server 125 may perform data pre-processing of the genetic data to convert raw sequences of base pairs to sequences of genotypes at target SNP sites. Since a typical human genome may differ from a reference human genome at only several million SNP sites (as opposed to billions of base pairs in the whole genome), the genetic data extraction service server 125 may extract only the genotypes at a set of target SNP sites and transmit the extracted data to the computing server 130 as the genetic dataset of an individual. SNPs, base pair sequence, genotype, haplotype, RNA sequences, protein sequences, and phenotypes are examples of biomarkers. In some embodiments, each SNP site may have two readings that are heterozygous.

The computing server 130 performs various analyses of the genetic data, genealogy data, and users' survey responses to generate results regarding the phenotypes and genealogy of users of computing server 130. Depending on the embodiments, the computing server 130 may also be referred to as an online server, a personal genetic service server, a genealogy server, a family tree building server, and/or a social networking system. The computing server 130 receives genetic data from the genetic data extraction service server 125 and stores the genetic data in the data store of the computing server 130. The computing server 130 may analyze the data to generate results regarding the genetics or genealogy of users. The results regarding the genetics or genealogy of users may include the ethnicity compositions of users, paternal and maternal genetic analysis, identification or suggestion of potential family relatives, ancestor information, analyses of DNA data, potential or identified traits such as phenotypes of users (e.g., diseases, appearance traits, other genetic characteristics, and other non-genetic characteristics including social characteristics), etc. The computing server 130 may present or cause the user interface 115 to present the results to the users through a GUI displayed at the client device 110. The results may include graphical elements, textual information, data, charts, and other elements such as family trees.

In some embodiments, the computing server 130 also allows various users to create one or more genealogical profiles of the user. The genealogical profile may include a list of individuals (e.g., ancestors, relatives, friends, and other people of interest) who are added or selected by the user or suggested by the computing server 130 based on the genealogical records and/or genetic records. The user interface 115 controlled by or in communication with the computing server 130 may display the individuals in a list or as a family tree such as in the form of a pedigree chart. In some embodiments, subject to user's privacy setting and authorization, the computing server 130 may allow information generated from the user's genetic dataset to be linked to the user profile and to one or more of the family trees. The users may also authorize the computing server 130 to analyze their genetic dataset and allow their profiles to be discovered by other users.

### Example Computing Server Architecture

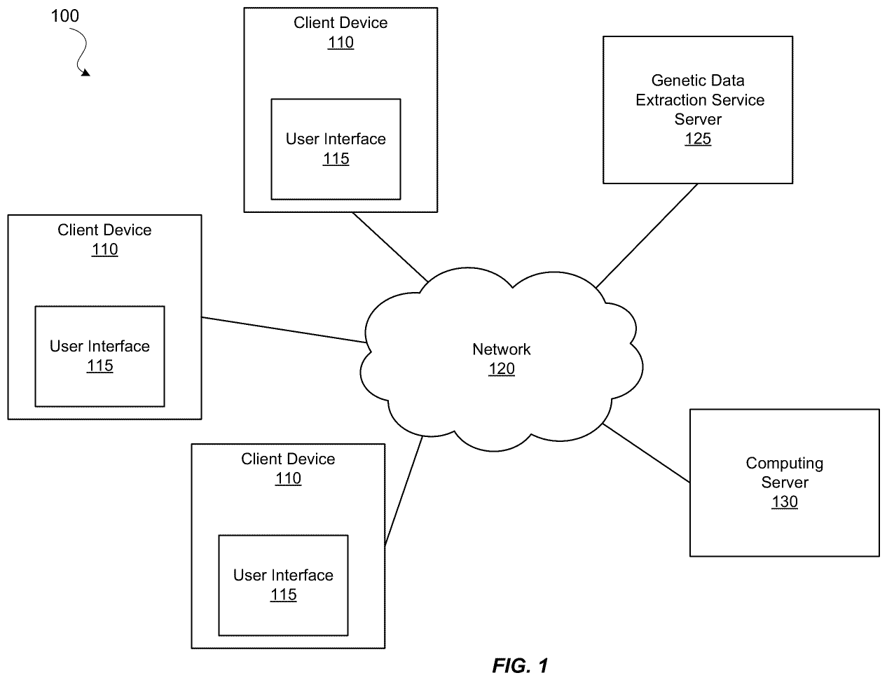

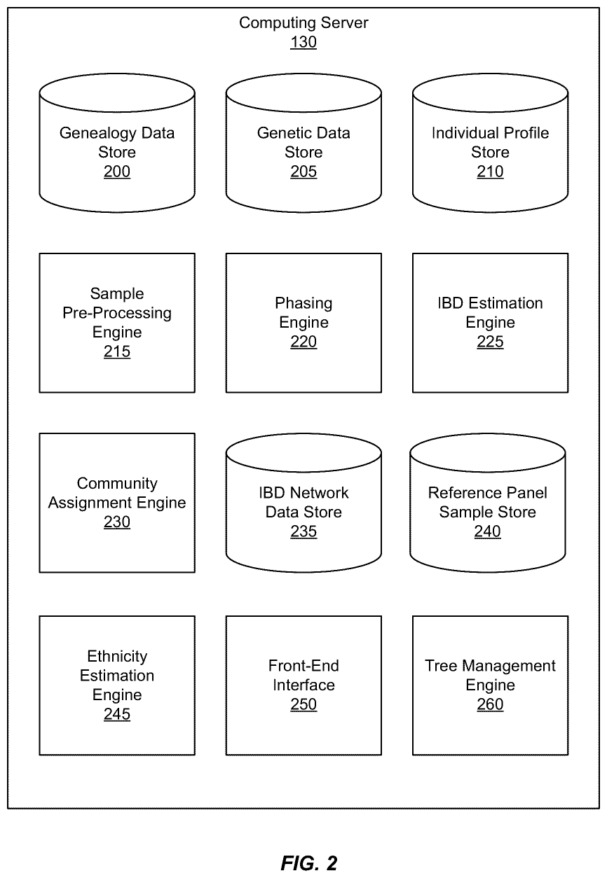

FIG. 2 is a block diagram of an architecture of an example computing server 130, in accordance with some embodiments. In the embodiment shown in FIG. 2, the computing server 130 includes a genealogy data store 200, a genetic data store 205, an individual profile store 210, a sample pre-processing engine 215, a phasing engine 220, an identity by descent (IBD) estimation engine 225, a community assignment engine 230, an IBD network data store 235, a reference panel sample store 240, an ethnicity estimation engine 245, a front-end interface 250, and a tree management engine 260. The functions of the computing server 130 may be distributed among the elements in a different manner than described. In various embodiments, the computing server 130 may include different components and fewer or additional components. Each of the various data stores may be a single storage device, a server controlling multiple storage devices, or a distributed network that is accessible through multiple nodes (e.g., a cloud storage system).

The computing server 130 stores various data of different individuals, including genetic data, genealogy data, and survey response data. The computing server 130 processes the genetic data of users to identify shared identity-by-descent (IBD) segments between individuals. The genealogy data and survey response data may be part of user profile data. The amount and type of user profile data stored for each user may vary based on the information of a user, which is provided by the user as she creates an account and profile at a system operated by the computing server 130 and continues to build her profile, family tree, and social network at the system and to link her profile with her genetic data. Users may provide data via the user interface 115 of a client device 110. Initially and as a user continues to build her genealogical profile, the user may be prompted to answer questions related to the basic information of the user (e.g., name, date of birth, birthplace, etc.) and later on more advanced questions that may be useful for obtaining additional genealogy data. The computing server 130 may also include survey questions regarding various traits of the users such as the users' phenotypes, characteristics, preferences, habits, lifestyle, environment, etc.

Genealogy data may be stored in the genealogy data store 200 and may include various types of data that are related to tracing family relatives of users. Examples of genealogy data include names (first, last, middle, suffixes), gender, birth locations, date of birth, date of death, marriage information, spouse's information kinships, family history, dates and places for life events (e.g., birth and death), other vital data, and the like. In some instances, family history can take the form of a pedigree of an individual (e.g., the recorded relationships in the family). The family tree information associated with an individual may include one or more specified nodes. Each node in the family tree represents the individual, an ancestor of the individual who might have passed down genetic material to the individual, and the individual's other relatives including siblings, cousins, and offspring in some cases. Genealogy data may also include connections and relationships among users of the computing server 130. The information related to the connections among a user and her relatives that may be associated with a family tree may also be referred to as pedigree data or family tree data.

In addition to user-input data, genealogy data may also take other forms that are obtained from various sources such as public records and third-party data collectors. For example, genealogical records from public sources include birth records, marriage records, death records, census records, court records, probate records, adoption records, obituary records, etc. Likewise, genealogy data may include data from one or more family trees of an individual, the Ancestry World Tree system, a Social Security Death Index database, the World Family Tree system, a birth certificate database, a death certificate database, a marriage certificate database, an adoption database, a draft registration database, a veterans database, a military database, a property records database, a census database, a voter registration database, a phone database, an address database, a newspaper database, an immigration database, a family history records database, a local history records database, a business registration database, a motor vehicle database, and the like.

Furthermore, the genealogy data store 200 may also include relationship information inferred from the genetic data stored in the genetic data store 205 and information received from the individuals. For example, the relationship information may indicate which individuals are genetically related, how they are related, how many generations back they share common ancestors, lengths and locations of IBD segments shared, which genetic communities an individual is a part of, variants carried by the individual, and the like.

The computing server 130 maintains genetic datasets of individuals in the genetic data store 205. A genetic dataset of an individual may be a digital dataset of nucleotide data (e.g., SNP data) and corresponding metadata. A genetic dataset may contain data on the whole or portions of an individual's genome. The genetic data store 205 may store a pointer to a location associated with the genealogy data store 200 associated with the individual. A genetic dataset may take different forms. In some embodiments, a genetic dataset may take the form of a base pair sequence of the sequencing result of an individual. A base pair sequence dataset may include the whole genome of the individual (e.g., obtained from a whole-genome sequencing) or some parts of the genome (e.g., genetic loci of interest).

In another embodiment, a genetic dataset may take the form of sequences of genetic markers. Examples of genetic markers may include target SNP sites (e.g., allele sites) filtered from the sequencing results. A SNP site that is single base pair long may also be referred to a SNP locus. A SNP site may be associated with a unique identifier. The genetic dataset may be in a form of diploid data that includes a sequencing of genotypes, such as genotypes at the target SNP site, or the whole base pair sequence that includes genotypes at known SNP site and other base pair sites that are not commonly associated with known SNPs. The diploid dataset may be referred to as a genotype dataset or a genotype sequence. Genotype may have a different meaning in various contexts. In one context, an individual's genotype may refer to a collection of diploid alleles of an individual. In other contexts, a genotype may be a pair of alleles present on two chromosomes for an individual at a given genetic marker such as a SNP site.

Genotype data for a SNP site may include a pair of alleles. The pair of alleles may be homozygous (e.g., A-A or G-G) or heterozygous (e.g., A-T, C-T). Instead of storing the actual nucleotides, the genetic data store 205 may store genetic data that are converted to bits. For a given SNP site, oftentimes only two nucleotide alleles (instead of all 4) are observed. As such, a 2-bit number may represent a SNP site. For example, 00 may represent homozygous first alleles, 11 may represent homozygous second alleles, and 01 or 10 may represent heterozygous alleles. A separate library may store what nucleotide corresponds to the first allele and what nucleotide corresponds to the second allele at a given SNP site.

A diploid dataset may also be phased into two sets of haploid data, one corresponding to a first parent side and another corresponding to a second parent side. The phased datasets may be referred to as haplotype datasets or haplotype sequences. Similar to genotype, haplotype may have a different meaning in various contexts. In one context, a haplotype may also refer to a collection of alleles that corresponds to a genetic segment. In other contexts, a haplotype may refer to a specific allele at a SNP site. For example, a sequence of haplotypes may refer to a sequence of alleles of an individual that are inherited from a parent.

The individual profile store 210 stores profiles and related metadata associated with various individuals appeared in the computing server 130. The individual profile store 210 may also be referred to as a named-entity data store. A computing server 130 may use unique individual identifiers to identify various users and other non-users that might appear in other data sources such as ancestors or historical persons who appear in any family tree or genealogy database. A unique individual identifier may be a hash of certain identification information of an individual, such as a user's account name, user's name, date of birth, location of birth, or any suitable combination of the information. The profile data related to an individual may be stored as metadata associated with an individual's profile. For example, the unique individual identifier and the metadata may be stored as a key-value pair using the unique individual identifier as a key.

An individual's profile data may include various kinds of information related to the individual. The metadata about the individual may include one or more pointers associating genetic datasets such as genotype and phased haplotype data of the individual that are saved in the genetic data store 205. The metadata about the individual may also be individual information related to family trees and pedigree datasets that include the individual. The profile data may further include declarative information about the user that was authorized by the user to be shared and may also include information inferred by the computing server 130. Other examples of information stored in a user profile may include biographic, demographic, and other types of descriptive information such as work experience, educational history, gender, hobbies, or preferences, location and the like. In some embodiments, the user profile data may also include one or more photos of the users and photos of relatives (e.g., ancestors) of the users that are uploaded by the users. A user may authorize the computing server 130 to analyze one or more photos to extract information, such as the user's or relative's appearance traits (e.g., blue eyes, curved hair, etc.), from the photos. The appearance traits and other information extracted from the photos may also be saved in the profile store. In some cases, the computing server may allow users to upload many different photos of the users, their relatives, and even friends. User profile data may also be obtained from other suitable sources, including historical records (e.g., records related to an ancestor), medical records, military records, photographs, other records indicating one or more traits, and other suitable recorded data.

For example, the computing server 130 may present various survey questions to its users from time to time. The responses to the survey questions may be stored at individual profile store 210. The survey questions may be related to various aspects of the users and the users' families. Some survey questions may be related to users' phenotypes, while other questions may be related to environmental factors of the users.

Survey questions may concern health or disease-related phenotypes, such as questions related to the presence or absence of genetic diseases or disorders, inheritable diseases or disorders, or other common diseases or disorders that have a family history as one of the risk factors, questions regarding any diagnosis of increased risk of any diseases or disorders, and questions concerning wellness-related issues such as a family history of obesity, family history of causes of death, etc. The diseases identified by the survey questions may be related to single-gene diseases or disorders that are caused by a single-nucleotide variant, an insertion, or a deletion. The diseases identified by the survey questions may also be multifactorial inheritance disorders that may be caused by a combination of environmental factors and genes. Examples of multifactorial inheritance disorders may include heart disease, Alzheimer's disease, diabetes, cancer, and obesity. The computing server 130 may obtain data on a user's disease-related phenotypes from survey questions about the health history of the user and her family and also from health records uploaded by the user.

Survey questions also may be related to other types of phenotypes such as appearance traits of the users. A survey regarding appearance traits and characteristics may include questions related to eye color, iris pattern, freckles, chin types, finger length, dimple chin, earlobe types, hair color, hair curl, skin pigmentation, susceptibility to skin burn, bitter taste, male baldness, baldness pattern, presence of unibrow, presence of wisdom teeth, height, and weight. A survey regarding other traits also may include questions related to users' taste and smell such as the ability to taste bitterness, asparagus smell, cilantro aversion, etc. A survey regarding traits may further include questions related to users' body conditions such as lactose tolerance, caffeine consumption, malaria resistance, norovirus resistance, muscle performance, alcohol flush, etc. Other survey questions regarding a person's physiological or psychological traits may include vitamin traits and sensory traits such as the ability to sense an asparagus metabolite. Traits may also be collected from historical records, electronic health records and electronic medical records.

The computing server 130 also may present various survey questions related to the environmental factors of users. In this context, an environmental factor may be a factor that is not directly connected to the genetics of the users. Environmental factors may include users' preferences, habits, and lifestyles. For example, a survey regarding users' preferences may include questions related to things and activities that users like or dislike, such as types of music a user enjoys, dancing preference, party-going preference, certain sports that a user plays, video game preferences, etc. Other questions may be related to the users' diet preferences such as like or dislike a certain type of food (e.g., ice cream, egg). A survey related to habits and lifestyle may include questions regarding smoking habits, alcohol consumption and frequency, daily exercise duration, sleeping habits (e.g., morning person versus night person), sleeping cycles and problems, hobbies, and travel preferences. Additional environmental factors may include diet amount (calories, macronutrients), physical fitness abilities (e.g., stretching, flexibility, heart rate recovery), family type (adopted family or not, has siblings or not, lived with extended family during childhood), property and item ownership (has home or rents, has a smartphone or doesn't, has a car or doesn't).

Surveys also may be related to other environmental factors such as geographical, social-economic, or cultural factors. Geographical questions may include questions related to the birth location, family migration history, town, or city of users' current or past residence. Social-economic questions may be related to users' education level, income, occupations, self-identified demographic groups, etc. Questions related to culture may concern users' native language, language spoken at home, customs, dietary practices, etc. Other questions related to users' cultural and behavioral questions are also possible.

For any survey questions asked, the computing server 130 may also ask an individual the same or similar questions regarding the traits and environmental factors of the ancestors, family members, other relatives or friends of the individual. For example, a user may be asked about the native language of the user and the native languages of the user's parents and grandparents. A user may also be asked about the health history of his or her family members.

In addition to storing the survey data in the individual profile store 210, the computing server 130 may store some responses that correspond to data related to genealogical and genetics respectively to genealogy data store 200 and genetic data store 205.

The user profile data, photos of users, survey response data, the genetic data, and the genealogy data may be subject to the privacy and authorization setting of the users to specify any data related to the users that can be accessed, stored, obtained, or otherwise used. For example, when presented with a survey question, a user may select to answer or skip the question. The computing server 130 may present users from time to time information regarding users' selection of the extent of information and data shared. The computing server 130 also may maintain and enforce one or more privacy settings for users in connection with the access of the user profile data, photos, genetic data, and other sensitive data. For example, the user may pre-authorize the access to the data and may change the setting as wished. The privacy settings also may allow a user to specify (e.g., by opting out, by not opting in) whether the computing server 130 may receive, collect, log, or store particular data associated with the user for any purpose. A user may restrict her data at various levels. For example, on one level, the data may not be accessed by the computing server 130 for purposes other than displaying the data in the user's own profile. On another level, the user may authorize anonymization of her data and participate in studies and research conducted by the computing server 130 such as a large-scale genetic study. On yet another level, the user may turn some portions of her genealogy data public to allow the user to be discovered by other users (e.g., potential relatives) and be connected to one or more family trees. Access or sharing of any information or data in the computing server 130 may also be subject to one or more similar privacy policies. A user's data and content objects in the computing server 130 may also be associated with different levels of restriction. The computing server 130 may also provide various notification features to inform and remind users of their privacy and access settings. For example, when privacy settings for a data entry allow a particular user or other entities to access the data, the data may be described as being “visible,” “public,” or other suitable labels, contrary to a “private” label.

In some cases, the computing server 130 may have a heightened privacy protection on certain types of data and data related to certain vulnerable groups. In some cases, the heightened privacy settings may strictly prohibit the use, analysis, and sharing of data related to a certain vulnerable group. In other cases, the heightened privacy settings may specify that data subject to those settings require prior approval for access, publication, or other use. In some cases, the computing server 130 may provide the heightened privacy as a default setting for certain types of data, such as genetic data or any data that the user marks as sensitive. The user may opt in to sharing of those data or change the default privacy settings. In other cases, the heightened privacy settings may apply across the board for all data of certain groups of users. For example, if computing server 130 determines that the user is a minor or has recognized that a picture of a minor is uploaded, the computing server 130 may designate all profile data associated with the minor as sensitive. In those cases, the computing server 130 may have one or more extra steps in seeking and confirming any sharing or use of the sensitive data.

The sample pre-processing engine 215 receives and pre-processes data received from various sources to change the data into a format used by the computing server 130. For genealogy data, the sample pre-processing engine 215 may receive data from an individual via the user interface 115 of the client device 110. To collect the user data (e.g., genealogical and survey data), the computing server 130 may cause an interactive user interface on the client device 110 to display interface elements in which users can provide genealogy data and survey data. Additional data may be obtained from scans of public records. The data may be manually provided or automatically extracted via, for example, optical character recognition (OCR) performed on census records, town or government records, or any other item of printed or online material. Some records may be obtained by digitalizing written records such as older census records, birth certificates, death certificates, etc.

The sample pre-processing engine 215 may also receive raw data from genetic data extraction service server 125. The genetic data extraction service server 125 may perform laboratory analysis of biological samples of users and generate sequencing results in the form of digital data. The sample pre-processing engine 215 may receive the raw genetic datasets from the genetic data extraction service server 125. Most of the mutations that are passed down to descendants are related to single-nucleotide polymorphism (SNP). SNP is a substitution of a single nucleotide that occurs at a specific position in the genome. The sample pre-processing engine 215 may convert the raw base pair sequence into a sequence of genotypes of target SNP sites. Alternatively, the pre-processing of this conversion may be performed by the genetic data extraction service server 125. The sample pre-processing engine 215 identifies autosomal SNPs in an individual's genetic dataset. In some embodiments, the SNPs may be autosomal SNPs. In some embodiments, 700,000 SNPs may be identified in an individual's data and may be stored in genetic data store 205. Alternatively, in some embodiments, a genetic dataset may include at least 10,000 SNP sites. In another embodiment, a genetic dataset may include at least 100,000 SNP sites. In yet another embodiment, a genetic dataset may include at least 300,000 SNP sites. In yet another embodiment, a genetic dataset may include at least 1,000,000 SNP sites. The sample pre-processing engine 215 may also convert the nucleotides into bits. The identified SNPs, in bits or in other suitable formats, may be provided to the phasing engine 220 which phases the individual's diploid genotypes to generate a pair of haplotypes for each user.

The phasing engine 220 phases diploid genetic dataset into a pair of haploid genetic datasets and may perform imputation of SNP values at certain sites whose alleles are missing. An individual's haplotype may refer to a collection of alleles (e.g., a sequence of alleles) that are inherited from a parent.

Phasing may include a process of determining the assignment of alleles (particularly heterozygous alleles) to chromosomes. Owing to sequencing conditions and other constraints, a sequencing result often includes data regarding a pair of alleles at a given SNP locus of a pair of chromosomes but may not be able to distinguish which allele belongs to which specific chromosome. The phasing engine 220 uses a genotype phasing algorithm to assign one allele to a first chromosome and another allele to another chromosome. The genotype phasing algorithm may be developed based on an assumption of linkage disequilibrium (LD), which states that haplotype in the form of a sequence of alleles tends to cluster together. The phasing engine 220 is configured to generate phased sequences that are also commonly observed in many other samples. Put differently, haplotype sequences of different individuals tend to cluster together. A haplotype-cluster model may be generated to determine the probability distribution of a haplotype that includes a sequence of alleles. The haplotype-cluster model may be trained based on labeled data that includes known phased haplotypes from a trio (parents and a child). A trio is used as a training sample because the correct phasing of the child is almost certain by comparing the child's genotypes to the parent's genetic datasets. The haplotype-cluster model may be generated iteratively along with the phasing process with a large number of unphased genotype datasets. The haplotype-cluster model may also be used to impute one or more missing data.

By way of example, the phasing engine 220 may use a directed acyclic graph model such as a hidden Markov model (HMM) to perform the phasing of a target genotype dataset. The directed acyclic graph may include multiple levels, each level having multiple nodes representing different possibilities of haplotype clusters. An emission probability of a node, which may represent the probability of having a particular haplotype cluster given an observation of the genotypes may be determined based on the probability distribution of the haplotype-cluster model. A transition probability from one node to another may be initially assigned to a non-zero value and be adjusted as the directed acyclic graph model and the haplotype-cluster model are trained. Various paths are possible in traversing different levels of the directed acyclic graph model. The phasing engine 220 determines a statistically likely path, such as the most probable path or a probable path that is at least more likely than 95% of other possible paths, based on the transition probabilities and the emission probabilities. A suitable dynamic programming algorithm such as the Viterbi algorithm may be used to determine the path. The determined path may represent the phasing result. U.S. Pat. No. 10,679,729, entitled “Haplotype Phasing Models,” granted on Jun. 9, 2020, describes example embodiments of haplotype phasing.

A phasing algorithm may also generate phasing result that has a long-distance accuracy in terms of haplotype separation. For example, in some embodiments, a jig phasing algorithm may be used, which is described in further detail in U.S. Patent Application Publication No. US 2021/0034647, entitled “Clustering of Matched Segments to Determine Linkage of Dataset in a Database,” published on Feb. 4, 2021. For example, the computing server 130 may receive a target individual genotype dataset and a plurality of additional individual genotype datasets that include haplotypes of additional individuals. For example, the additional individuals may be reference panels or individuals who are linked (e.g., in a family tree) to the target individual. The computing server 130 may generate a plurality of sub-cluster pairs of first parental groups and second parental groups. Each sub-cluster pair may be in a window. The window may correspond to a genomic segment and has a similar concept of window used in the ethnicity estimation engine 245 and the rest of the disclosure related to HMMs, but how windows are precisely divided and defined may be the same or different in the phasing engine 220 and in an HMM. Each sub-cluster pair may correspond to a genetic locus. In some embodiments, each sub-cluster pair may have a first parental group that includes a first set of matched haplotype segments selected from the plurality of additional individual datasets and a second parental group that includes a second set of matched haplotype segments selected from the plurality of additional individual datasets. The computing server 130 may generate a super-cluster of a parental side by linking the first parental groups and the second parental groups across a plurality of genetic loci (across a plurality of sub-cluster pairs). Generating the super-cluster of the parental side may include generating a candidate parental side assignment of parental groups across a set of sub-cluster pairs that represent a set of genetic loci in the plurality of genetic loci. The computing server 130 may determine a number of common additional individual genotype datasets that are classified in the candidate parental side assignment. The computing server 130 may determine the candidate parental side assignment to be part of the super-cluster based on the number of common additional individual genotype datasets. Any suitable algorithms may be used to generate the super-cluster, such as a heuristic scoring approach, a bipartite graph approach, or another suitable approach. The computing server 130 may generate a haplotype phasing of the target individual from the super-cluster of the parental side.

The IBD estimation engine 225 estimates the amount of shared genetic segments between a pair of individuals based on phased genotype data (e.g., haplotype datasets) that are stored in the genetic data store 205. IBD segments may be segments identified in a pair of individuals that are putatively determined to be inherited from a common ancestor. The IBD estimation engine 225 retrieves a pair of haplotype datasets for each individual. The IBD estimation engine 225 may divide each haplotype dataset sequence into a plurality of windows. Each window may include a fixed number of SNP sites (e.g., about 100 SNP sites). The IBD estimation engine 225 identifies one or more seed windows in which the alleles at all SNP sites in at least one of the phased haplotypes between two individuals are identical. The IBD estimation engine 225 may expand the match from the seed windows to nearby windows until the matched windows reach the end of a chromosome or until a homozygous mismatch is found, which indicates the mismatch is not attributable to potential errors in phasing or imputation. The IBD estimation engine 225 determines the total length of matched segments, which may also be referred to as IBD segments. The length may be measured in the genetic distance in the unit of centimorgans (cM). A unit of centimorgan may be a genetic length. For example, two genomic positions that are one cM apart may have a 1% chance during each meiosis of experiencing a recombination event between the two positions. The computing server 130 may save data regarding individual pairs who share a length of IBD segments exceeding a predetermined threshold (e.g., 6 cM), in a suitable data store such as in the genealogy data store 200. U.S. Pat. No. 10,114,922, entitled “Identifying Ancestral Relationships Using a Continuous stream of Input,” granted on Oct. 30, 2018, and U.S. Pat. No. 10,720,229, entitled “Reducing Error in Predicted Genetic Relationships,” granted on Jul. 21, 2020, describe example embodiments of IBD estimation.

Typically, individuals who are closely related share a relatively large number of IBD segments, and the IBD segments tend to have longer lengths (individually or in aggregate across one or more chromosomes). In contrast, individuals who are more distantly related share relatively fewer IBD segments, and these segments tend to be shorter (individually or in aggregate across one or more chromosomes). For example, while close family members often share upwards of 71 cM of IBD (e.g., third cousins), more distantly related individuals may share less than 12 cM of IBD. The extent of relatedness in terms of IBD segments between two individuals may be referred to as IBD affinity. For example, the IBD affinity may be measured in terms of the length of IBD segments shared between two individuals.

Community assignment engine 230 assigns individuals to one or more genetic communities based on the genetic data of the individuals. A genetic community may correspond to an ethnic origin or a group of people descended from a common ancestor. The granularity of genetic community classification may vary depending on embodiments and methods used to assign communities. For example, in some embodiments, the communities may be African, Asian, European, etc. In another embodiment, the European community may be divided into Irish, German, Swedes, etc. In yet another embodiment, the Irish may be further divided into Irish in Ireland, Irish immigrated to America in 1800, Irish immigrated to America in 1900, etc. The community classification may also depend on whether a population is admixed or unadmixed. For an admixed population, the classification may further be divided based on different ethnic origins in a geographical region.

Community assignment engine 230 may assign individuals to one or more genetic communities based on their genetic datasets using machine learning models trained by unsupervised learning or supervised learning. In an unsupervised approach, the community assignment engine 230 may generate data representing a partially connected undirected graph. In this approach, the community assignment engine 230 represents individuals as nodes. Some nodes are connected by edges whose weights are based on IBD affinity between two individuals represented by the nodes. For example, if the total length of two individuals' shared IBD segments does not exceed a predetermined threshold, the nodes are not connected. The edges connecting two nodes are associated with weights that are measured based on the IBD affinities. The undirected graph may be referred to as an IBD network. The community assignment engine 230 uses clustering techniques such as modularity measurement (e.g., the Louvain method) to classify nodes into different clusters in the IBD network. Each cluster may represent a community. The community assignment engine 230 may also determine sub-clusters, which represent sub-communities. The computing server 130 saves the data representing the IBD network and clusters in the IBD network data store 235. U.S. Pat. No. 10,223,498, entitled “Discovering Population Structure from Patterns of Identity-By-Descent,” granted on Mar. 5, 2019, describes example embodiments of community detection and assignment.

The community assignment engine 230 may also assign communities using supervised techniques. For example, genetic datasets of known genetic communities (e.g., individuals with confirmed ethnic origins) may be used as training sets that have labels of the genetic communities. Supervised machine learning classifiers, such as logistic regressions, support vector machines, random forest classifiers, and neural networks may be trained using the training set with labels. A trained classifier may distinguish binary or multiple classes. For example, a binary classifier may be trained for each community of interest to determine whether a target individual's genetic dataset belongs or does not belong to the community of interest. A multi-class classifier such as a neural network may also be trained to determine whether the target individual's genetic dataset most likely belongs to one of several possible genetic communities.

Reference panel sample store 240 stores reference panel samples for different genetic communities. A reference panel sample is a genetic data of an individual whose genetic data is the most representative of a genetic community. The genetic data of individuals with the typical alleles of a genetic community may serve as reference panel samples. For example, some alleles of genes may be over-represented (e.g., being highly common) in a genetic community. Some genetic datasets include alleles that are commonly present among members of the community. Reference panel samples may be used to train various machine learning models in classifying whether a target genetic dataset belongs to a community, determining the ethnic composition of an individual, and determining the accuracy of any genetic data analysis, such as by computing a posterior probability of a classification result from a classifier.

A reference panel sample may be identified in different ways. In some embodiments, an unsupervised approach in community detection may apply the clustering algorithm recursively for each identified cluster until the sub-clusters contain a number of nodes that are smaller than a threshold (e.g., contains fewer than 1000 nodes). For example, the community assignment engine 230 may construct a full IBD network that includes a set of individuals represented by nodes and generate communities using clustering techniques. The community assignment engine 230 may randomly sample a subset of nodes to generate a sampled IBD network. The community assignment engine 230 may recursively apply clustering techniques to generate communities in the sampled IBD network. The sampling and clustering may be repeated for different randomly generated sampled IBD networks for various runs. Nodes that are consistently assigned to the same genetic community when sampled in various runs may be classified as a reference panel sample. The community assignment engine 230 may measure the consistency in terms of a predetermined threshold. For example, if a node is classified to the same community 95% (or another suitable threshold) of the times whenever the node is sampled, the genetic dataset corresponding to the individual represented by the node may be regarded as a reference panel sample. Additionally, or alternatively, the community assignment engine 230 may select N most consistently assigned nodes as a reference panel for the community.

Other ways to generate reference panel samples are also possible. For example, the computing server 130 may collect a set of samples and gradually filter and refine the samples until high-quality reference panel samples are selected. For example, a candidate reference panel sample may be selected from an individual whose recent ancestors are born at a certain birthplace. The computing server 130 may also draw sequence data from the Human Genome Diversity Project (HGDP). Various candidates may be manually screened based on their family trees, relatives' birth location, and other quality control. Principal component analysis may be used to create clusters of genetic data of the candidates. Each cluster may represent an ethnicity. The predictions of the ethnicity of those candidates may be compared to the ethnicity information provided by the candidates to perform further screening.

The ethnicity estimation engine 245 estimates the ethnicity composition of a genetic dataset of a target individual. The genetic datasets used by the ethnicity estimation engine 245 may be genotype datasets or haplotype datasets. For example, the ethnicity estimation engine 245 estimates the ancestral origins (e.g., ethnicity) based on the individual's genotypes or haplotypes at the SNP sites. To take a simple example of three ancestral populations corresponding to African, European and Native American, an admixed user may have nonzero estimated ethnicity proportions for all three ancestral populations, with an estimate such as [0.05, 0.65, 0.30], indicating that the user's genome is 5% attributable to African ancestry, 65% attributable to European ancestry and 30% attributable to Native American ancestry. The ethnicity estimation engine 245 generates the ethnic composition estimate and stores the estimated ethnicities in a data store of computing server 130 with a pointer in association with a particular user.

In some embodiments, the ethnicity estimation engine 245 divides a target genetic dataset into a plurality of windows (e.g., about 1000 windows). Each window includes a small number of SNPs (e.g., 300 SNPs). The ethnicity estimation engine 245 may use a directed acyclic graph model to determine the ethnic composition of the target genetic dataset. The directed acyclic graph may represent a trellis of an inter-window hidden Markov model (HMM). The graph includes a sequence of a plurality of node groups. Each node group, representing a window, includes a plurality of nodes. The nodes represent different possibilities of labels of genetic communities (e.g., ethnicities) for the window. A node may be labeled with one or more ethnic labels. For example, a level includes a first node with a first label representing the likelihood that the window of SNP sites belongs to a first ethnicity and a second node with a second label representing the likelihood that the window of SNPs belongs to a second ethnicity. Each level includes multiple nodes so that there are many possible paths to traverse the directed acyclic graph.

The nodes and edges in the directed acyclic graph may be associated with different emission probabilities and transition probabilities. An emission probability associated with a node represents the likelihood that the window belongs to the ethnicity labeling the node given the observation of SNPs in the window. The ethnicity estimation engine 245 determines the emission probabilities by comparing SNPs in the window corresponding to the target genetic dataset to corresponding SNPs in the windows in various reference panel samples of different genetic communities stored in the reference panel sample store 240. The transition probability between two nodes represents the likelihood of transition from one node to another across two levels. The ethnicity estimation engine 245 determines a statistically likely path, such as the most probable path or a probable path that is at least more likely than 95% of other possible paths, based on the transition probabilities and the emission probabilities. A suitable dynamic programming algorithm such as the Viterbi algorithm or the forward-backward algorithm may be used to determine the path. After the path is determined, the ethnicity estimation engine 245 determines the ethnic composition of the target genetic dataset by determining the label compositions of the nodes that are included in the determined path. U.S. Pat. No. 10,558,930, entitled “Local Genetic Ethnicity Determination System,” granted on Feb. 11, 2020 and U.S. Pat. No. 10,692,587, granted on Jun. 23, 2020, entitled “Global Ancestry Determination System” describe different example embodiments of ethnicity estimation.

The front-end interface 250 displays various results determined by the computing server 130. The results and data may include the IBD affinity between a user and another individual, the community assignment of the user, the ethnicity estimation of the user, phenotype prediction and evaluation, genealogy data search, family tree and pedigree, relative profile and other information. The front-end interface 250 may allow users to manage their profile and data trees (e.g., family trees). The users may view various public family trees stored in the computing server 130 and search for individuals and their genealogy data via the front-end interface 250. The computing server 130 may suggest or allow the user to manually review and select potentially related individuals (e.g., relatives, ancestors, close family members) to add to the user's data tree. The front-end interface 250 may be a graphical user interface (GUI) that displays various information and graphical elements. The front-end interface 250 may take different forms. In one case, the front-end interface 250 may be a software application that can be displayed on an electronic device such as a computer or a smartphone. The software application may be developed by the entity controlling the computing server 130 and be downloaded and installed on the client device 110. In another case, the front-end interface 250 may take the form of a webpage interface of the computing server 130 that allows users to access their family tree and genetic analysis results through web browsers. In yet another case, the front-end interface 250 may provide an application program interface (API).

The tree management engine 260 performs computations and other processes related to users' management of their data trees such as family trees. The tree management engine 260 may allow a user to build a data tree from scratch or to link the user to existing data trees. In some embodiments, the tree management engine 260 may suggest a connection between a target individual and a family tree that exists in the family tree database by identifying potential family trees for the target individual and identifying one or more most probable positions in a potential family tree. A user (target individual) may wish to identify family trees to which he or she may potentially belong. Linking a user to a family tree or building a family may be performed automatically, manually, or using techniques with a combination of both. In an embodiment of an automatic tree matching, the tree management engine 260 may receive a genetic dataset from the target individual as input and search related individuals that are IBD-related to the target individual. The tree management engine 260 may identify common ancestors. Each common ancestor may be common to the target individual and one of the related individuals. The tree management engine 260 may in turn output potential family trees to which the target individual may belong by retrieving family trees that include a common ancestor and an individual who is IBD-related to the target individual. The tree management engine 260 may further identify one or more probable positions in one of the potential family trees based on information associated with matched genetic data between the target individual and those in the potential family trees through one or more machine learning models or other heuristic algorithms. For example, the tree management engine 260 may try putting the target individual in various possible locations in the family tree and determine the highest probability position(s) based on the genetic dataset of the target individual and genetic datasets available for others in the family tree and based on genealogy data available to the tree management engine 260. The tree management engine 260 may provide one or more family trees from which the target individual may select. For a suggested family tree, the tree management engine 260 may also provide information on how the target individual is related to other individuals in the tree. In a manual tree building, a user may browse through public family trees and public individual entries in the genealogy data store 200 and individual profile store 210 to look for potential relatives that can be added to the user's family tree. The tree management engine 260 may automatically search, rank, and suggest individuals for the user to conduct manual reviews as the user makes progress in the front-end interface 250 in building the family tree.

As used herein, “pedigree” and “family tree” may be interchangeable and may refer to a family tree chart or pedigree chart that shows, diagrammatically, family information, such as family history information, including parentage, offspring, spouses, siblings, or otherwise for any suitable number of generations and/or people, and/or data pertaining to persons represented in the chart. U.S. Pat. No. 11,429,615, entitled “Linking Individual Datasets to a Database,” granted on Aug. 30, 2022, describes example embodiments of how an individual may be linked to existing family trees.

### Example Characteristic Extraction Process

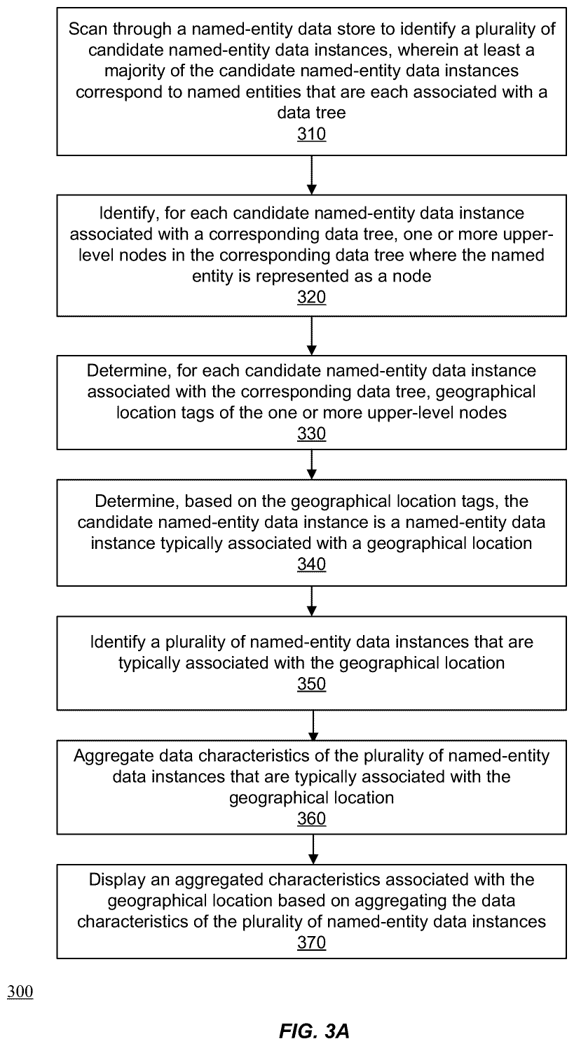

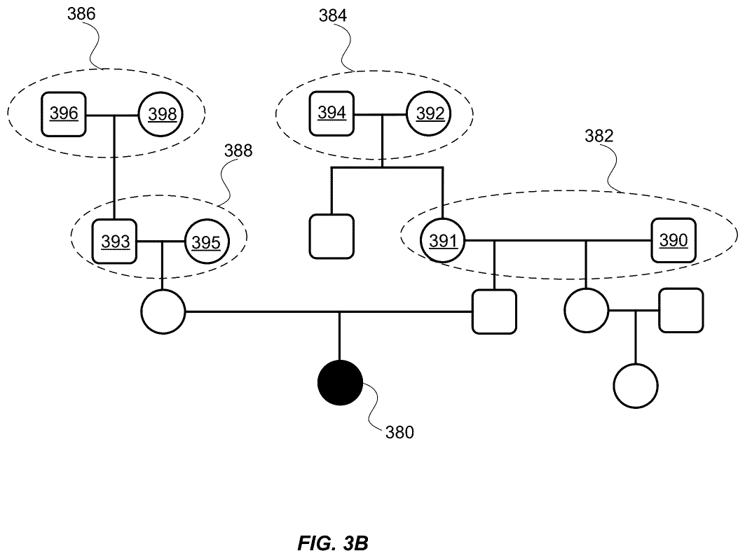

FIG. 3A is a flowchart depicting an example process 300 for extracting characteristics of a set of representative data instances that are typically associated with a geographical location, in accordance with some embodiments. The process may be performed by one or more engines of the computing server 130 illustrated in FIG. 2. The process 300 may be embodied as a software algorithm that may be stored as computer instructions that are executable by one or more processors. The instructions, when executed by the processors, cause the processors to perform various steps in the process 300. In various embodiments, the process may include additional, fewer, or different steps. While various steps in process 300 may be discussed with the use of computing server 130, each step may be performed by a different computing device.

In some embodiments, process 300 can include scanning through a named-entity data store to identify a plurality of candidate named-entity data instances (step 310). In various embodiments, a named-entity data store may be an individual user profile data store such as the individual profile store 210. While name entities are described using natural persons as examples, in some embodiments, other named entities, such as communities of individuals, organizations, and other suitable named entities may also be analyzed.

In some embodiments, a named-entity data instance may be an entry of data related to a named entity. For example, a named-entity data instance may be a user or other personal profile stored in individual profile store 210, a genealogy record that records a life event of the named entity and that is stored in genealogy data store 200, a genetic dataset that includes genomic sequences of a natural person and that is stored in genetic data store 205, or another suitable data instance, whether the data instance is genetic or genealogical in nature, dynamically changing or constant, historical or present. In some embodiments, a named-entity data instance may be nested so that the data instance is linked to additional sub-instances or other data instances of different natures. By way of example, in some embodiments, a named-entity data instance may be a user profile of the computing server 130. Within the user profile, the named-entity data instance may include a link to a genetic dataset of the user who has performed a DNA test provided by the genetic data extraction service server 125, a link to a family tree that is built manually by the user or partially or fully automatically by the computing server 130, a link to one or more genealogical records that describes events and other data that are related to the user. In this example, the genetic dataset, the family tree instance, and the genealogical records may also be named-entity data instances that are nested under the user profile.

In some embodiments, a named-entity data store may be a large-scale data store. For example, the named-entity data store may be individual profile store 210. In some embodiments, the individual profile store 210 may include at least 10,000 named-entity data records in the form of user profiles and each user profile may be associated with one or more genetic datasets and one or more genealogical data entries. In some embodiments, the individual profile store 210 may include at least 50,000 named-entity data records in the form of user profiles and each user profile may be associated with one or more genetic datasets and one or more genealogical data entries. In some embodiments, the individual profile store 210 may include at least 100,000 named-entity data records in the form of user profiles and each user profile may be associated with one or more genetic datasets and one or more genealogical data entries. In some embodiments, the individual profile store 210 may include at least 500,000 named-entity data records in the form of user profiles and each user profile may be associated with one or more genetic datasets and one or more genealogical data entries. In some embodiments, the individual profile store 210 may include at least 1,000,000 named-entity data records in the form of user profiles and each user profile may be associated with one or more genetic datasets and one or more genealogical data entries. In some embodiments, the individual profile store 210 may include at least 2,000,000 named-entity data records in the form of user profiles and each user profile may be associated with one or more genetic datasets and one or more genealogical data entries. In some embodiments, the individual profile store 210 may include at least 5,000,000 named-entity data records in the form of user profiles and each user profile may be associated with one or more genetic datasets and one or more genealogical data entries. In some embodiments, the individual profile store 210 may include at least 10,000,000 named-entity data records in the form of user profiles and each user profile may be associated with one or more genetic datasets and one or more genealogical data entries. In some embodiments, scanning through the named-entity data store is a computer process that cannot be performed mentally or using a manual process such as manually looking through the named-entity data instance one by one.

In some embodiments, the identification of a plurality of candidate named-entity data instances may be based on one or more preliminary criteria that allow the computing server 130 to scan through a large number of data instances efficiently and quickly. In some embodiments, an example criterion is the presence of a genetic dataset associated with a candidate named-entity data instance. For example, the computing server 130 may scan through user profiles of the individual profile store 210 and filter away user profiles that are not associated with any genetic datasets (e.g., users who have not done DNA tests with the computing server 130). The user profiles with the genetic data may serve as candidate named-entity data instances. Additionally, or alternatively, the scanning criteria may include the presence of a family tree associated with a user profile. Additionally, or alternatively, the scanning criteria may include the presence of at least one grandparent or an earlier ancestor in the family tree. Additionally, or alternatively, the scanning criteria may include the existence of geographical location (e.g., birth location) data entry of at least one grandparent or an earlier ancestor in the family tree. Other suitable filtering criteria may be used to identify candidate named-entity data instances. In some embodiments, the computing server 130 may scan through user profiles and identify user profiles who have genetic data and a family tree that has one or more grandparents who are associated with genealogical records (e.g., birth certificates, Census records) that indicate the birth locations of the grandparents. User profiles that do not meet the criteria may be filtered away and are not used as candidate named-entity data instances.

In some embodiments, by using one or more filtering criteria, at least a majority of the candidate named-entity data instances identified by the computing server 130 correspond to named entities that are each associated with a data tree. In some embodiments, the data tree may represent data inheritance of data instances based on real-world events. For example, data instances may be derived from other data instances based on real-world events and inherit some characteristics of antecedent data instances. The relationship of inheritance of data instances may be represented by a data tree that represents the relationships among the nodes in the data tree. Family tree is an example of a data tree that illustrates relationships of inheritance of data instances. The nodes of the family tree may represent individuals whose genetic data are passed down from ancestors. Marriage and other family relationships are real-world events that are represented by the family tree. The family tree links individuals by edges that link the individual nodes to represent familial relationships and inheritance of genetic sequences of individuals in the family. A candidate named-entity data instance that corresponds to a named entity that is associated with a data tree may take the form of a user profile that has a family tree stored in the computing server 130. For example, the computing server 130 may select the user profiles as candidates if the user profiles correspond to users who have family trees stored in the computing server 130. In some embodiments, the user profiles that are selected as candidates are all associated with at least one family tree. In some embodiments, at least a majority of user profiles that are selected as candidates are associated with at least one family tree.

In some embodiments, a named-entity data instance is associated with a data tree when the named entity corresponding to the named-entity data instance is represented as a node in the data tree. For example, if a natural person is associated with a family tree, the user or personal profile or the genetic dataset of the natural person is said to be associated with the family tree.

Continuing with reference to FIG. 3A, in some embodiments, process 300 can include identifying, for each candidate named-entity data instance associated with a corresponding data tree, one or more upper-level nodes in the corresponding data tree where the named entity is represented as a node (step 320). An upper-level node is positioned higher, in the data tree, than the node representing the named entity. For example, in the context of a family tree, an upper-level node may be an ancestor of a target individual.

FIG. 3B is a conceptual diagram illustrating a data tree, in accordance with some embodiments. The node 380 may be the node that represents the target named entity corresponding to a candidate named-entity data instance. The node 380 in this situation may also be referred to as a leaf node. Other nodes in the data tree are at least one level higher than the node 380 and may be referred to as upper-level nodes. In some embodiments, a node may be traced up in the data tree and no node is above that particular node. Those nodes may be referred to as root nodes or terminal nodes. For example, in FIG. 3B, nodes 390, 392, 394, 395, 396, and 398 may be referred to as terminal nodes because no node is above those nodes. In some embodiments, nodes are separated by one or more levels. For example, the nodes in the bubble 382 are separated from the target node 380 by two levels and may represent the grandparents of the target named entity. The nodes in the bubble 384 are separated from the target node 380 by three levels and may represent the great grandparents of the target named entity.

In some embodiments, FIG. 3B is a diagram showing the identification of terminals of a particular user's pedigree, such as a pedigree associated with a selected DNA user. Terminals may include the nodes 390, 392, 394, 395, 396, and 398 (representing tree persons), which may represent the uppermost extent of a user's pedigree (e.g., the last-identified or last-identifiable persons in the pedigree) in a given branch. Some of the terminals may be great-grandparents while others may be parents or grandparents, as the case may be. Some branches may extend even farther than great-grandparents, such as when the user has a well-established or extensive pedigree including birth, marriage, and/or death locations extending back numerous generations. For example, in the particular example pedigree shown in FIG. 3B, grandparents 390 and 395 are terminal nodes and great grandparents 392, 394, 396, and 398 are terminal nodes. The pedigrees may be identified and retrieved from any suitable database, such as a stitched pedigree database, an unstitched pedigree database, or otherwise. Pedigrees are examples of data trees used in the process 300 and more examples of how pedigrees are generated are discussed in tree management engine 260.

In some embodiments, not all upper-level nodes are selected by the computing server 130. The computing server 130 may impose one or more criteria in selecting which upper-level nodes are examined. In some embodiments, the selected upper-level nodes are terminal nodes. In some embodiments, the selected upper-level nodes are nodes that are separated from the node representing the named entity for at least two levels or more in the data tree. For example, in some embodiments, only nodes that represent grandparents or great grandparents are selected for further examination. In some embodiments where a user has four grandparents in the pedigree but the birth location is only available for the two paternal grandparents and their mother (and not available for the maternal grandparents), the paternal grandparents and the mother may be selected as the terminals. In some embodiments, the computing server 130 may preferentially select only terminal nodes unless no geographical information is available to a terminal node. In such a case, the computing server 130 may select a node below the terminal node. For example, if no geographical information is available for nodes 396 and 398, the computing server 130 may select node 393 instead.

In some embodiments, the number of levels of separation required for an upper-level node to be selected may depend on the geographical location. Different geographical locations may have different required levels of separation. For one geographical location, nodes that are at the grandparent level are considered. For another geographical location, only nodes that are at the great grandparent level or beyond are considered. For example, in a geographical location where a known mitigation event occurred in a certain time period, the number of levels of separation selected may be based on the mitigation event to select the upper-level nodes with birth years that predate the mitigation event. Other criteria of selecting upper-level nodes are also possible. For example, in addition to a threshold level of separation, the computing server 130 may also require one or more selected upper-level nodes to be terminal nodes.

Continuing with reference to FIG. 3A, in some embodiments, process 300 can include determining, for each candidate named-entity data instance associated with the corresponding data tree, geographical location tags of the one or more upper-level nodes (step 330). By way of example, the computing server 130 may individually examine the data tree of each named entity and identify one or more upper-level nodes in the data tree based on the criteria discussed in step 320. The computing server 130 may examine the geographical location tag associated with each upper-level node. The geographical location tag may be assigned based on one or more genealogical data instance associated with the upper-level node. For example, the geographical location tag may take the form of birth location tag and the genealogical data instance may be the birth record of the natural person represented by the upper-level node. Geographical locations, such as birth locations, may be determined for tree persons represented by the terminal nodes. For example, a location utility such as a historical location database may be used to assign or ascertain birth locations such as a specific country based on historical or other data. In some embodiments, the location utility utilizes or accounts for historical boundaries, assigns birth locations (e.g., town, city, or province) to a modern country and optionally subregion of a modern country.

The geographical location used in the process 300 may be of any suitable granularity. The geographical location can be a country, historical or present, a subregion of a country, a known geographical region that inhabits a distinctive cultural group, sub-regions that are identifiable, or any other suitable location that may be defined by the computing server 130 or by a user. In some embodiments, the computing server 130 may present a geographical map (e.g., a world map) to a user in a graphical user interface and allows the user to select the geographical location of interest. In response, the computing server 130 may perform the process 300 to generate results for the user. In some embodiments, in presenting the geographical map, the computing server 130 may allow the user to customize a geographical boundary to tailor a user-generated geographical location.

Continuing with reference to FIG. 3A, in some embodiments, process 300 can include determining, based on the geographical location tags, the candidate named-entity data instance is a named-entity data instance typically associated with a geographical location (step 340). A named-entity data instance that is typically associated with a geographical location may refer to a typical native named entity of the geographical location. The determination of whether a particular candidate named-entity data instance is qualified as a data instance that is typically associated with the geographical location may depend on the consensus among the geographical location tags of those upper-level nodes. For example, if the geographical location tags of the upper-level nodes of the target named entity all agree and point to the same geographical location, the computing server 130 may determine that the target named entity is typically associated with the geographical location. Using the application of birth location and typical native as an example, the computing server 130 may identify a candidate user who has a family tree stored in the computing server 130. The computing server 130 identifies the geographical location tags of the grandparents and/or great grandparents in the family tree of the candidate user. If the geographical location tags agree with each other and point to the same geographical location, the computing server 130 may determine that the candidate user is a typical native of the geographical location and regard the named-entity data instance corresponding to the candidate user as the data instance that is typically associated with the geographical location. The upper-level nodes that do not have geographical location tags available may be disregarded.

In some embodiments, the computing server 130 may use one or more rules in examining the consensus of the geographical location tags. By way of example, the computing server 130 may determine the geographical location tags of each of the one or more upper-level nodes that are selected. The computing server 130 may determine that the geographical location tags all correspond to a particular geographical location. The computing server 130 may determine that the particular candidate named-entity data instance is typically associated with the particular geographical location. In some embodiments, the consensus rule may be relaxed compared to requiring all geographical location tags to be in agreement. For example, if one of the geographical location tags is suspected to be in error, the computing server 130 may disregard the disagreement of that tag compared to the rest of the location tags of other upper-level nodes. In some embodiments, only geographical location tags of terminal nodes are used to determine whether a data instance qualifies as being typically associated with the geographical location.

For example, referring to the pedigree FIG. 3B, the node 380 representing the target named entity have grandparent information on both the father and mother side (either the square or the circle can represent a father or a mother, or vice versa) and great grandparent information associated with some grandparents. If the grandparents and the great grandparents on both paternal and maternal side have geographical location tags that agree with others (or within the same geographical radius), the target named entity represented by the node 380 may be determined to be a typical native of the geographical location.

In embodiments, the computing server 130 is configured to account for different levels of granularity in the geographic location associated with different terminal nodes for a particular data instance. For example, one terminal or upper-level node may be associated with a country based on a corresponding national Census record, while another terminal or upper-level node may be associated with a city or province of said country based on a birth, marriage, or death record. In embodiments, the computing server 130 is configured to associate the city within the country and the country as being a same, or sufficiently associated, geographical location for associating the data instance as a typical native data instance of or with, e.g., the country. Likewise, the computing server 130 may be configured to account for different types of data indicating the geographic location associated with particular terminal nodes, such as different types of historical records, user-inputted data entries, or otherwise.

Continuing with reference to FIG. 3A, in some embodiments, process 300 can include identifying a plurality of named-entity data instances that are typically associated with the geographical location (step 350). For example, the step 340 may be repeated for other candidate named-entity data instances to determine whether each of the data instances can be qualified as being typically associated with the geographical location. As discussed above, the named-entity data store may be a large scale one. The computing server 130 may scan through thousands or even millions of candidate named-entity data instances to identify a set of named-entity data instances that are qualified as being typically associated with the geographical location.

Continuing with reference to FIG. 3A, in some embodiments, process 300 can include aggregating data characteristics of the plurality of named-entity data instances that are typically associated with the geographical location (step 360). The data characteristics may take any suitable forms, such as any data characteristics related to the genealogy of the named-entity data instances (e.g., surnames, common genealogy patterns, common life events) that are recorded in one or more data instances stored in the genealogy data store 200, genetic data (e.g., common SNPs, ethnicity composition, communities) stored in the genetic data store 205, common phenotypes (e.g., common diseases, common observable biological traits) determined based on the genealogy or genetic data, and profile characteristics based on data stored in the individual profile store 210.

In some embodiments, each named-entity data instance that is determined to be typically associated with the geographical location has certain data characteristics. The computing server 130 aggregates the data characteristics by any suitable statistical methods, such as applying or determining average, sum, ranges, standard deviation, distributions, and other suitable ways to aggregate the data characteristics. In some embodiments, the data characteristics may take the form of sequence characteristics such as the genetic sequences of the natural persons who are determined to be typical natives of the geographical location. The aggregation may determine the ranges and distributions of one or more compositions in the sequences of various natural persons.

By way of example, in the application of birth location and typical native, the data characteristics can be ethnicity compositions and the named-entity data instances examined to generate the data characteristics can be genetic datasets of those individuals who are determined to typical natives to the geographical location because all (or most) of the grandparents (or great grandparents) of those individuals were born in the geographical location. In such a case, the data characteristics may include sequence compositions of the named-entity data instances. The computing server 130 may determine the genetic sequence compositions of the genetic datasets associated with those typical natives. In turn, the ethnicity compositions of the typical natives may be determined. The ethnicity compositions of the typical natives may be aggregated and a typical ethnicity composition for people who are the geographical location may be determined. The typical ethnicity composition may be presented as an averaged composition, a range of certain ethnicity composition, and/or a distribution.

In some embodiments, upon identifying and filtering users with terminal nodes that entirely or substantially entirely correspond to the same location, such as a country or subregion of a country, a typical-native ethnicity determination system, method, or computer-program product may be configured to determine an ethnicity estimate of a typical native by assigning the identified and filtered users to a panel and generating ethnicity estimates for the users in the panel. The ethnicity determination process may use any of the processes described in the sample pre-processing engine 215, the phasing engine 220, the IBD estimation engine 225, the community assignment engine 230, the IBD network data store 235, the reference panel sample store 240, and the ethnicity estimation engine 245. In some embodiments, the ethnicity estimation engine 245, including a hidden Markov model, is used to determine the sequence composition (e.g., ethnicity composition) of each named-entity data instance that is determined to be typically associated with the geographical location. By way of example, the computing server 130 may input a sequence (e.g., phased or unphased genetic data) in the named-entity data instance to a hidden Markov model. The computing server 130 may generate a composition of the sequence using the hidden Markov model. Details of how a hidden Markov model may be used is further described in the discussion associated with ethnicity estimation engine 245. The ethnicity composition may also be an admixed population.

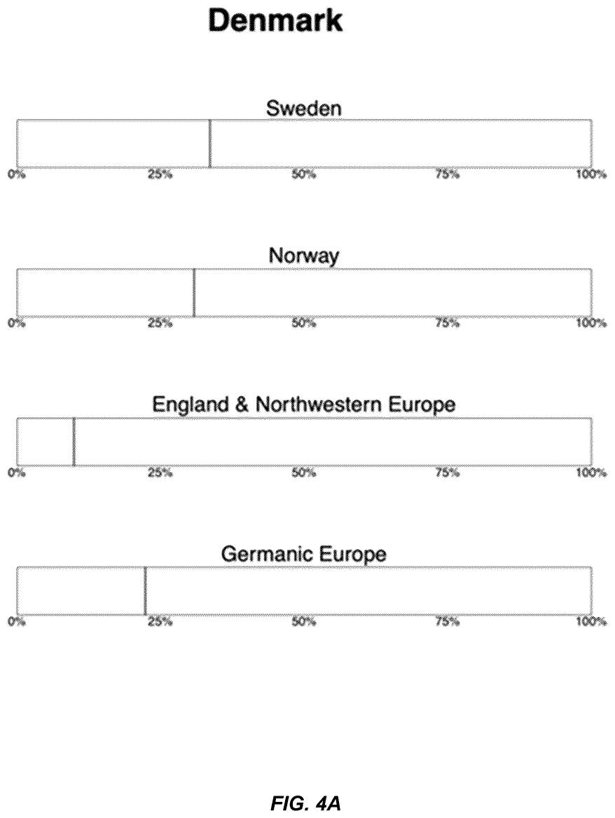

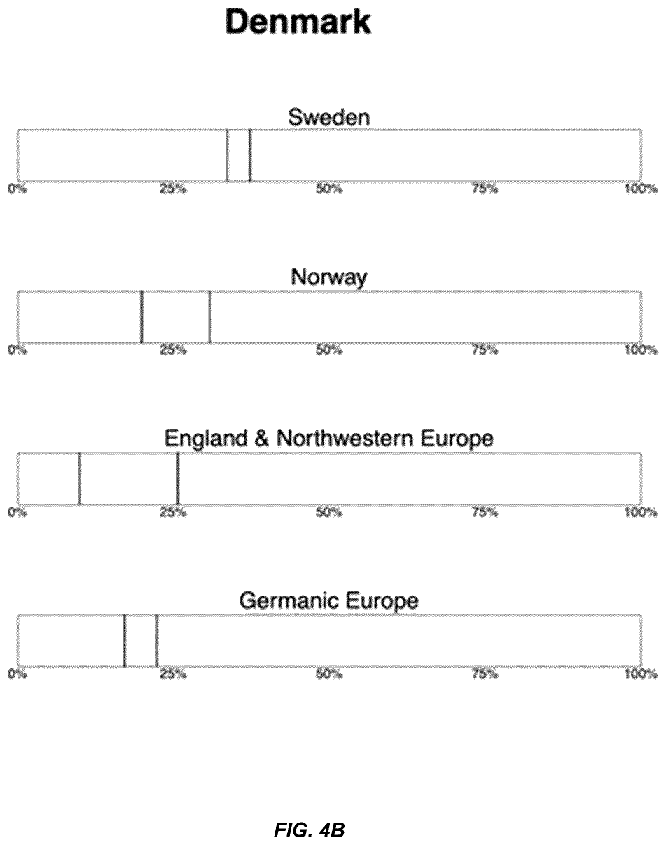

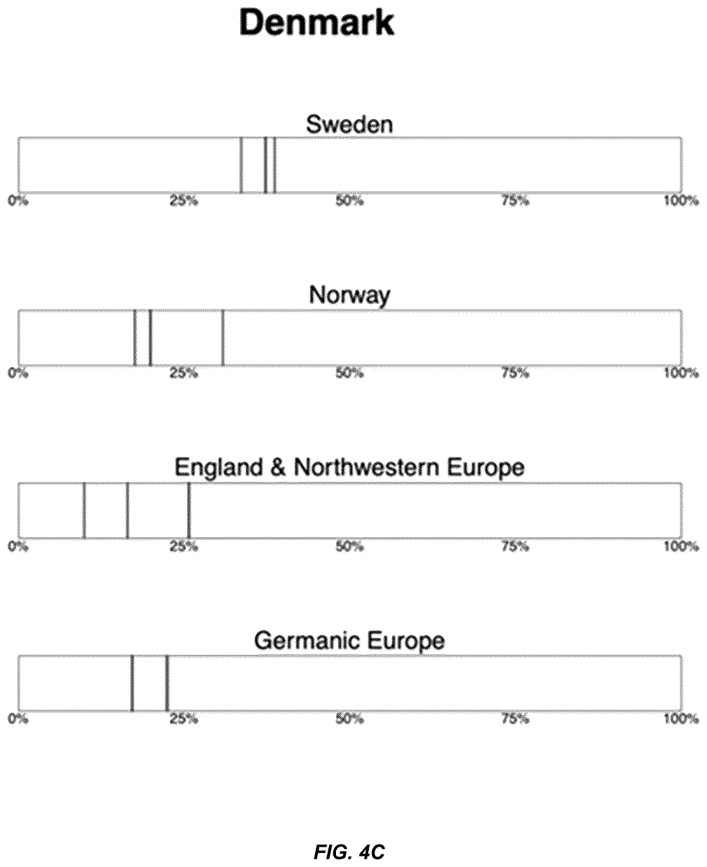

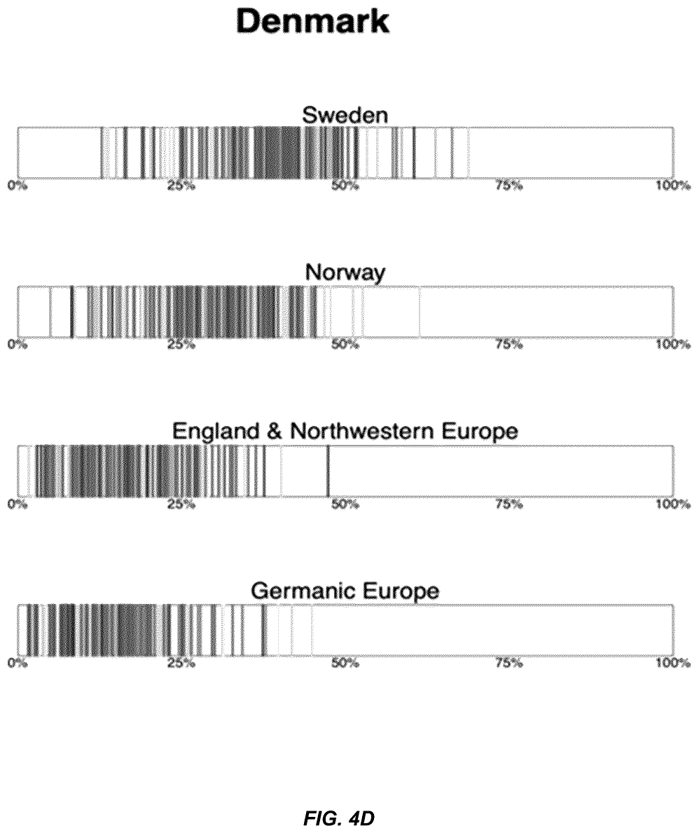

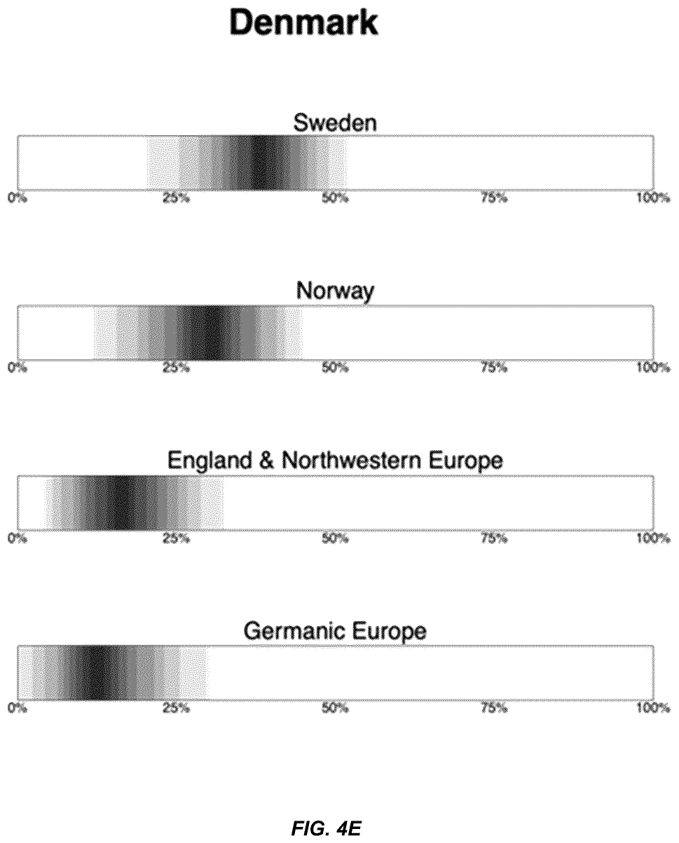

Continuing with reference to FIG. 3A, in some embodiments, process 300 can include displaying aggregated characteristics associated with the geographical location based on aggregating the data characteristics of the plurality of named-entity data instances (step 370). For example, the computing server 130 may display a distribution of one or more aggregated characteristics. Various examples of aggregated results are further discussed in FIG. 4A through FIG. 8B. In some embodiments, the computing server 130 may also add the plurality of named-entity data instances that are typically associated with the geographical location as a reference panel of the geographical location. The reference panel may represent the typical ethnicity composition of the geographical location.

While the process 300 is described as determining the typical data characteristics that are associated with one type of metadata which is a geographical location, the process 300 may also be used to determine the typical data characteristics that are associated with another commonality of metadata of a group of upper-level nodes. Instead of examining the geographical location tags of the selected upper-level nodes, the process 300 may examine other metadata tags of the selected upper-level nodes. For example, the computing server 130 may find typical natives of an admixed population. The computing server 130 may identify candidate individuals who have family trees. The computing server 130 determines the ethnicity compositions of the upper nodes in a family tree and determines that all grandparents (or great grandparents) belong to a target admixed population. As such, the computing server 130 may classify the candidate individual's data instance as being typically associated with the target admixed population. In turn, the computing server 130 may determine that each of the ethnicity compositions of those individuals who are classified as typically associated with the target admixed population and aggregate the ethnicity compositions to determine the typical ethnicity composition of the target admixed population. In some embodiments, a selection criterion other than a geographical location or a target admixed population may also be used, such as a common surname in the grandparent or great grandparent level.

### Typical Native Ethnicity Composition Examples

In some embodiments, the process 300 may be used to facilitate the determination of a typical-native ethnicity. In some embodiments, a method or system connects percentages from ethnicity estimates of users to ethnicity estimates of typical natives with deep roots from a place. In some embodiments, users are presented with greater detail about the expected DNA results for users with deep roots from a specific area or sub-area. The computing server 130 may cause a user interface to display a “DNA Summary” breakdown, indicating the average ethnicity profile for users from this area. It can also include expanding the polygon levels which are displayed from >25% assignment to >5% assignment or even >1% assignment to demonstrate that people from areas beyond the expected location may commonly get some assignment to a particular ethnicity region in the ethnicity reference panel. In some embodiments, the process 300 may further include eliminating an ethnicities layer and connecting a customer directly to regions, which may be connected to places. This may be done through determining ethnicities of typical natives (e.g., how much assignment to a region is typically seen in a given place).

It has been found that it is easiest to understand ethnicity estimates by looking at people with deep roots from the same place, e.g., people who (as determined using a user or customer assessment panel) have pedigrees to the same place, such as the same country and optionally subregion of a country. This is advantageously enabled by the combination of DNA data and family tree data which confirms the depth of a user's family roots in a place.

In some embodiments, users (named entities) are selected from a database by identifying users with associated DNA data, filtering non-DNA users, and identifying and accessing pedigrees corresponding to the DNA users. The database may be any suitable database, such as a stitched genealogical tree database, a database including DNA and pedigree data of users, or otherwise. Alternatively, or additionally, data from noncustomers samples that are publicly available or part of proprietary collections obtained with proper consent for such purposes may be utilized.

The data trees (e.g., pedigrees) of selected users are traced or otherwise evaluated to identify a plurality of upper-level nodes (e.g., terminal nodes) of the pedigrees. A terminal of a pedigree may include the utmost extent of the user's pedigree, such as the last-identified or last-identifiable ancestor in a particular family line. This may be one or more of a user's parent(s), grandparent(s), great-grandparent(s), and so on. All or substantially all terminals of a particular pedigree may be identified and/or evaluated. Metadata associated with persons in the pedigree, including individuals represented by the identified terminals, may also be retrieved. Such metadata may include, for example, birth location, marriage location, death location, etc.

Individual DNA users or tree persons with all or substantially all terminals of their pedigree corresponding to a particular geographical region and optionally subregion may be identified and optionally retrieved. Such users and their associated DNA and pedigree data may be retrieved and added to a typical-native reference panel representative of a specific region or subregion. For example, a DNA user who was born and raised in Kansas, USA may be selected as a representative of Northern England if their pedigree terminals all extend back to Northern England. In some embodiments, the disclosed system, methods, and/or computer-program products are agnostic to a user's birthplace and current location. Rather, their pedigree terminals may be determined to be relevant.

Outliers may be removed through an automatic filtering process. The automatic filtering process may be based on historical patterns specific to a certain subregion. The panel may be updated periodically (e.g., twice per year). One example of this is the use of a cross-continent assignment threshold for filtering, which is performed on a case-by-case basis.

Upon identifying and filtering users with terminals or terminal nodes that entirely or substantially entirely correspond to the same location, such as a country or subregion of a country, a typical-native ethnicity determination system, method, or computer-program product may be configured to determine an ethnicity estimate of a typical native by assigning the identified and filtered users to a panel and generating ethnicity estimates for the users in the panel.

FIGS. 4A-4E show graphs of a typical Danish user's ethnicity estimate attributable to particular countries. The graphs are examples of user interface elements that may be caused to display by the computing server 130 in a user interface. As seen in FIGS. 4A-4E, a first user with deep roots in Denmark, as evidenced by identified terminals in their associated pedigree, may have the ethnicity estimate shown in FIG. 4A. As shown by FIG. 4A, the first user whose family traces its roots back exclusively to Denmark may have an ethnicity estimate, determined, for example, by the ethnicity engine described above, of approximately 33% Swedish, 30% Norwegian, 10% English & Northwestern European, and 25% Germanic European.

A second user with deep and exclusive family roots in Denmark, as evidenced by identified terminals in their associated pedigree, may have the ethnicity estimate shown in FIG. 4B. As shown by FIG. 4B, by contrast, the second user whose family traces its roots back exclusively to Denmark may have an ethnicity estimate, determined, for example, by the ethnicity engine described above, of approximately 37% Swedish, 20% Norwegian, 25% English & Northwestern European, and 20% Germanic European.

This may be repeated for subsequent users in a Denmark typical-native reference panel, as shown in FIGS. 4C-4E. As shown in FIG. 4A through 4E, different ways of aggregating or presenting aggregated data may be possible in various embodiments. For example, in FIG. 4A, the average value for each ethnicity is presented. In FIGS. 4D and 4E, a range or a distribution using different greyscale may be used to present the typical ethnicity compositions.

As shown in FIG. 4E, the ethnicity estimates of the panel of users representative or typical of Denmark natives may include a range of ethnicity estimates from adjacent ethnic groups (e.g., a typical Dane may have an ethnicity estimate that shows 20%-55% Swedish ethnicity, 10%-40% Norwegian ethnicity). This allows a Danish or Danish-descent user to contextualize their own ethnicity estimate, bolstering their confidence in the estimate and providing a greater understanding of what their results may mean vis-à-vis their family history.

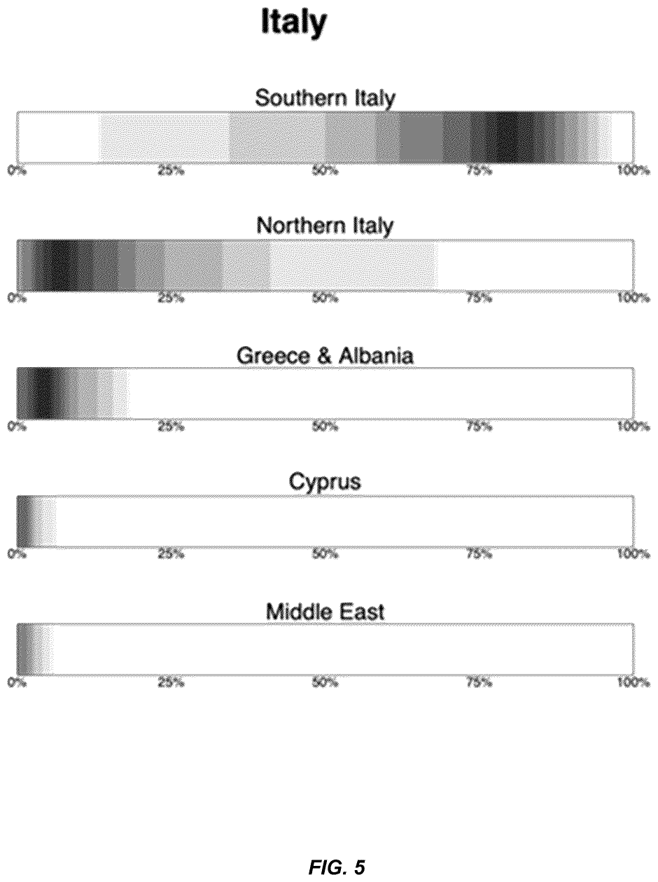

FIG. 5 shows a similarly constructed panel of typical natives of Italy. The constructed panel may be used as a reference panel for typical natives of a target geographical location. As shown in FIG. 5, a user with Italian ethnicity or ancestry may be better able to understand and appreciate their ethnicity estimate in view of the fact that a typical Italian, e.g., a person with deep roots in Italy, has ethnicity estimates of between 12.5% and 90% Southern Italian, between 1% and 67% Northern Italian, and so on. It will be appreciated that the disclosed representation is merely exemplary, and other approaches for displaying the determined ranges for a typical native's ethnicity are contemplated. For example, a histogram may be constructed based on the data.

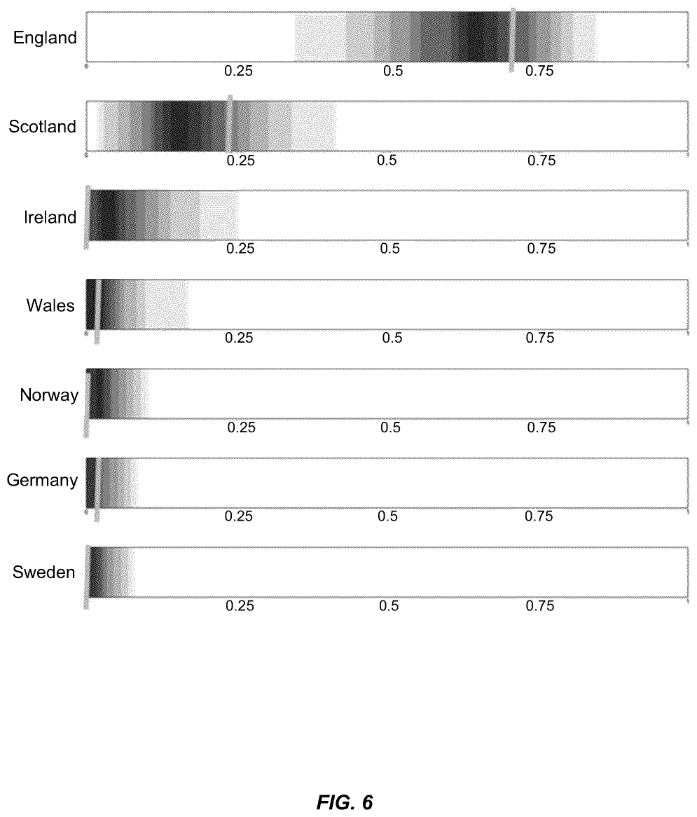

FIG. 6 shows that a computing server 130 may cause a user interface to display how an individual user's results may be juxtaposed against a typical native's ethnicity range or panel, for example against a typical English native. This approach advantageously mitigates potential confusion and distrust of ethnicity estimates generally, fosters an improved understanding of the results and the nature of ethnicities generally, and provides useful contextual information for users.

In some embodiments, a list of countries whose people the user's ethnicity estimates are more and less similar to may be determined and provided to the user. Additionally, or alternatively, a number of matches that have family trees back to each of said countries may be determined and provided. This can help a user identify places they are more likely to have ancestors from, and may help to directly link their origins to their family history. Country-specific typical native pages may be provided with links to matches with associated family trees to/in said country or related countries, results from a user's tree or a prompt to build a tree, typical native ethnicity results for the country, which may be personalized with the user's own ethnicity percentages, links to typical natives pages for subregions of the country (where available), historical perspectives on the country or related countries and their shared histories, combinations or modifications thereof, or any other suitable feature.

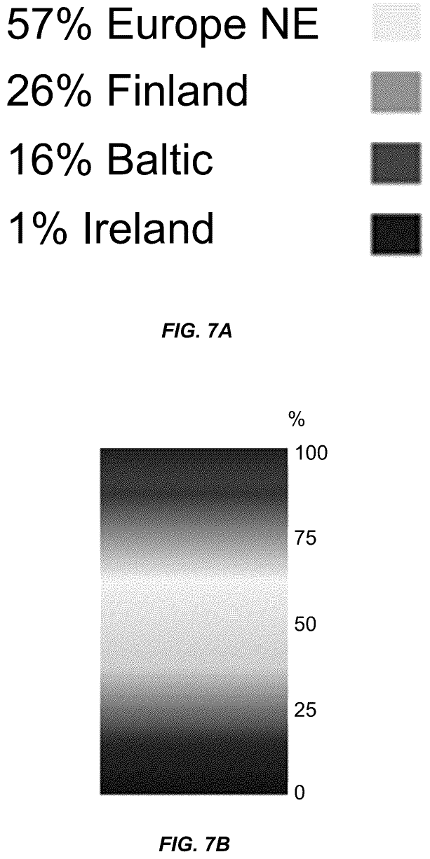

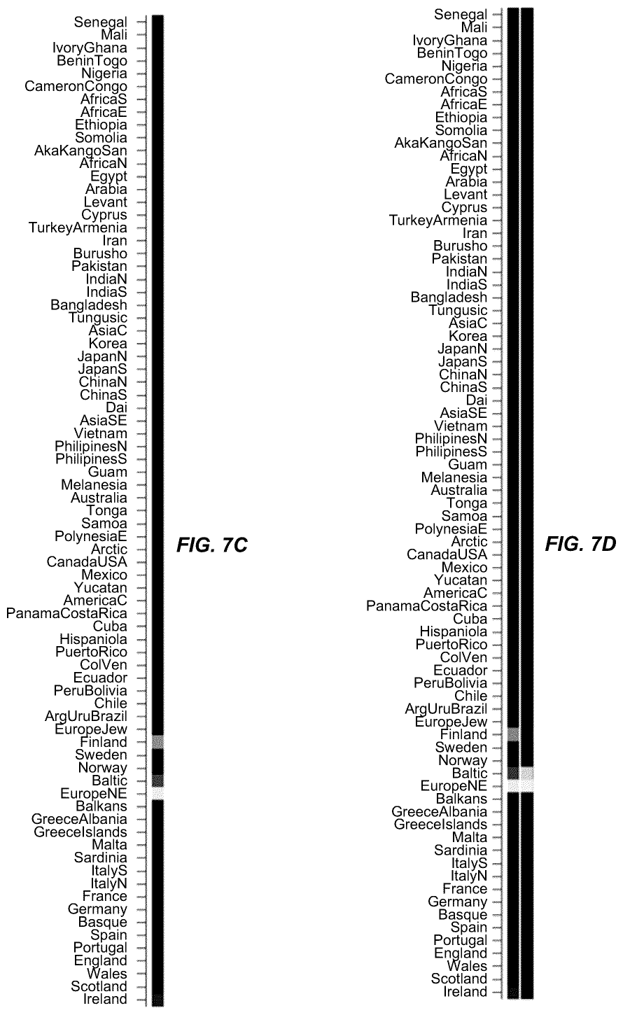

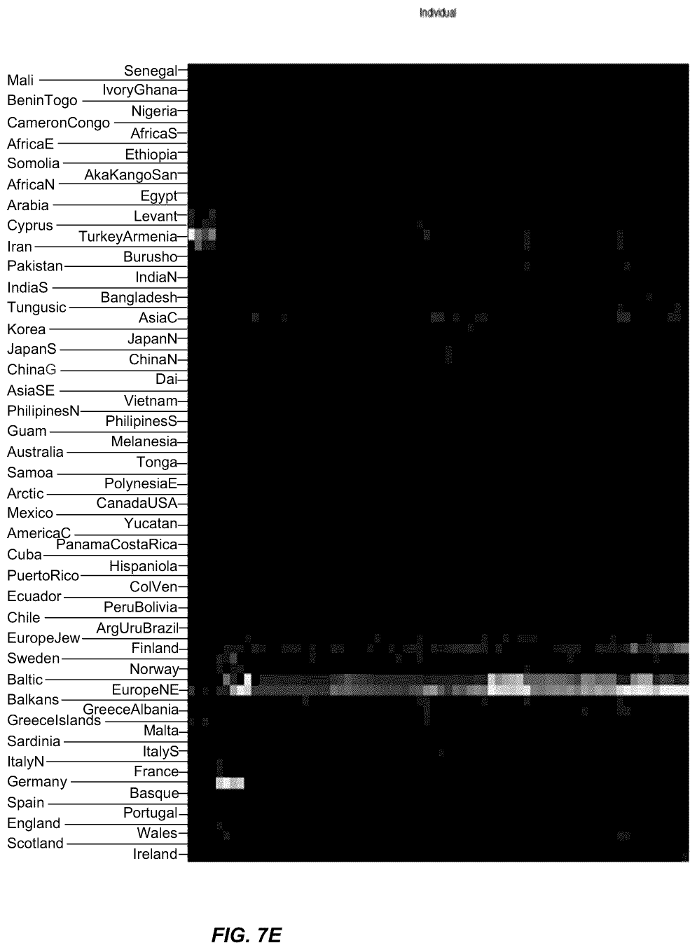

FIGS. 7A-7E depict diagrams for determining and presenting a typical native ethnicity, in accordance with some embodiments. FIG. 7A depicts an ethnicity estimate for a Russian user. FIG. 7B is a diagram of a color scale according to the percent assignment corresponding to the diagram of FIG. 7A, wherein the scale progresses from the top end (proximate 100% assignment) toward the bottom end (closer to 0% assignment) and ultimately to black (0% assignment).

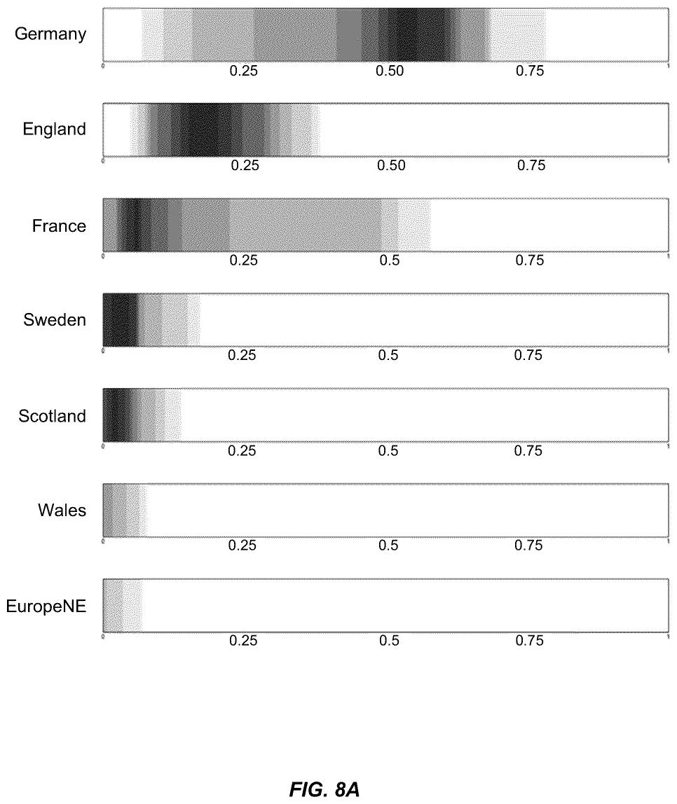

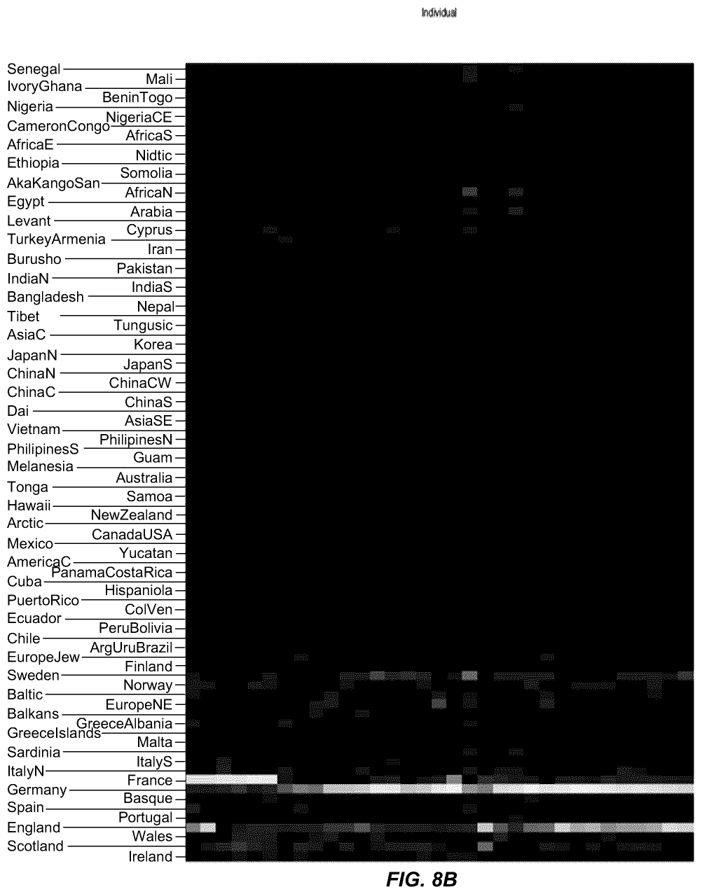

FIG. 7C is a diagram of ethnicity regions, arranged, in some embodiments, by region, with African ethnicity regions on the left, Asian ethnicity regions in the center left, American ethnicity regions in the center right, and European ethnicity regions on the right. A diagram as shown in FIG. 7C may correspond to a single user's ethnicity estimates. In the diagram of FIG. 7C, the regions or squares proximate an ethnicity region are colored for a user based on a percent assignment of the user's ethnicity estimate, as shown in the diagram of FIG. 7B. Black squares or regions are added for ethnicity regions with 0% estimate. In other words, a user with 57% EuropeNE ethnicity assignment will have the corresponding color for 57% from the diagram of FIG. 8B at the EuropeNE segment of FIG. 7C. FIG. 7D depicts a heatmap constructed by adding a second user's ethnicity regions to the first user's ethnicity regions, using a same or similar coloration approach. FIG. 7E depicts a heatmap constructed by adding a plurality of users' ethnicity regions, and illustrates a typical native ethnicity for, e.g., Russian users.

As shown in the heatmap of FIG. 7E, the typical natives of Russia have certain ranges of ethnicity percentages from regions including Baltic, Finland, Sweden, Norway, European Jew, Germany, and Turkey Armenia. It has been found that clustering of customers with similar ethnicity profiles helps identify population substructure that may remain hidden when only considering averages or ranges of ethnicity percentages. Similar heatmaps may be generated to illustrate a typical native of any suitable ethnicity region, such as Southwest England, Southeast England, East England, etc., with similarly informative results.

FIGS. 8A and 8B illustrate a profile and corresponding heatmap generated according to embodiments of the present disclosure for another region, specifically the Alsace Lorraine region of France.

### Computing Machine Architecture

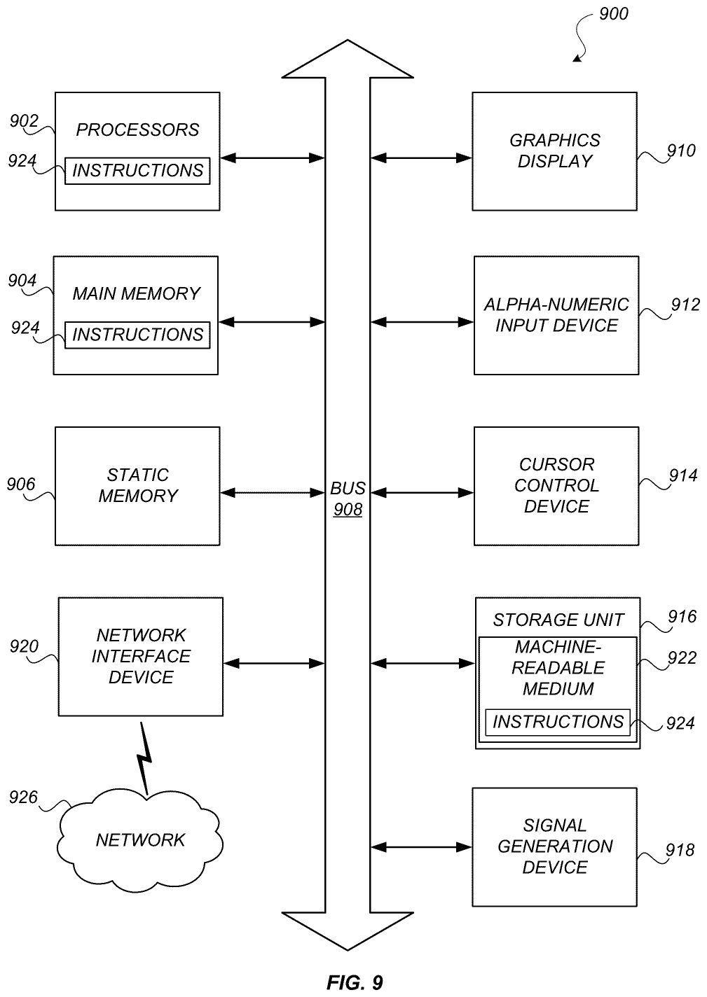

FIG. 9 is a block diagram illustrating components of an example computing machine that is capable of reading instructions from a computer-readable medium and execute them in a processor (or controller). A computer described herein may include a single computing machine shown in FIG. 9, a virtual machine, a distributed computing system that includes multiple nodes of computing machines shown in FIG. 9, or any other suitable arrangement of computing devices.

By way of example, FIG. 9 shows a diagrammatic representation of a computing machine in the example form of a computer system 900 within which instructions 924 (e.g., software, source code, program code, expanded code, object code, assembly code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 9 may correspond to any software, hardware, or combined components shown in FIGS. 1 and 2, including but not limited to, the client device 110, the computing server 130, and various engines, interfaces, terminals, and machines shown in FIG. 2. While FIG. 9 shows various hardware and software elements, each of the components described in FIGS. 1 and 2 may include additional or fewer elements.

By way of example, a computing machine may be a personal computer (PC), a tablet PC, a set-top box (STB), a personal digital assistant (PDA), a cellular telephone, a smartphone, a web appliance, a network router, an internet of things (IoT) device, a switch or bridge, or any machine capable of executing instructions 924 that specify actions to be taken by that machine. Further, while only a single machine is illustrated, the term “machine” and “computer” may also be taken to include any collection of machines that individually or jointly execute instructions 924 to perform any one or more of the methodologies discussed herein.

The example computer system 900 includes one or more processors 902 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 900 may also include a memory 904 that store computer code including instructions 924 that may cause the processors 902 to perform certain actions when the instructions are executed, directly or indirectly by the processors 902. Instructions can be any directions, commands, or orders that may be stored in different forms, such as equipment-readable instructions, programming instructions including source code, and other communication signals and orders. Instructions may be used in a general sense and are not limited to machine-readable codes. One or more steps in various processes described may be performed by passing through instructions to one or more multiply-accumulate (MAC) units of the processors.

One and more methods described herein improve the operation speed of the processors 902 and reduces the space required for the memory 904. For example, the database processing techniques described herein reduce the complexity of the computation of the processors 902 by applying one or more novel techniques that simplify the steps in scanning through a large scale named entity database. The algorithms described herein also reduces the size of the models and datasets to reduce the storage space requirement for memory 904.

The performance of certain operations may be distributed among more than one processor, not only residing within a single machine, but deployed across a number of machines. In some example embodiments, the one or more processors or processor-implemented modules may be located in a single geographic location (e.g., within a home environment, an office environment, or a server farm). In other example embodiments, one or more processors or processor-implemented modules may be distributed across a number of geographic locations. Even though in the specification or the claims may refer some processes to be performed by a processor, this should be construed to include a joint operation of multiple distributed processors. In some embodiments, a computer-readable medium comprises one or more computer-readable media that, individually, together, or distributedly, comprise instructions that, when executed by one or more processors, cause the one or more processors to perform, individually, together, or distributedly, the steps of the instructions stored on the one or more computer-readable media. Similarly, a processor comprises one or more processors or processing units that, individually, together, or distributedly, perform the steps of instructions stored on a computer-readable medium. In various embodiments, the discussion of one or more processors that carry out a process with multiple steps does not require any one of the processors to carry out all of the steps. For example, a processor A can carry out step A, a processor B can carry out step B using, for example, the result from the processor A, and a processor C can carry out step C, etc. The processors may work cooperatively in this type of situations such as in multiple processors of a system in a chip, in Cloud computing, or in distributed computing.

The computer system 900 may include a main memory 904, and a static memory 906, which are configured to communicate with each other via a bus 908. The computer system 900 may further include a graphics display unit 910 (e.g., a plasma display panel (PDP), a liquid crystal display (LCD), a projector, or a cathode ray tube (CRT)). The graphics display unit 910, controlled by the processors 902, displays a graphical user interface (GUI) to display one or more results and data generated by the processes described herein. The computer system 900 may also include alphanumeric input device 912 (e.g., a keyboard), a cursor control device 914 (e.g., a mouse, a trackball, a joystick, a motion sensor, or other pointing instruments), a storage unit 916 (a hard drive, a solid-state drive, a hybrid drive, a memory disk, etc.), a signal generation device 918 (e.g., a speaker), and a network interface device 920, which also are configured to communicate via the bus 908.

The storage unit 916 includes a computer-readable medium 922 on which is stored instructions 924 embodying any one or more of the methodologies or functions described herein. The instructions 924 may also reside, completely or at least partially, within the main memory 904 or within the processor 902 (e.g., within a processor's cache memory) during execution thereof by the computer system 900, the main memory 904 and the processor 902 also constituting computer-readable media. The instructions 924 may be transmitted or received over a network 926 via the network interface device 920.

While computer-readable medium 922 is shown in an example embodiment to be a single medium, the term “computer-readable medium” should be taken to include a single medium or multiple media (e.g., a centralized or distributed database, or associated caches and servers) able to store instructions (e.g., instructions 924). The computer-readable medium may include any medium that is capable of storing instructions (e.g., instructions 924) for execution by the processors (e.g., processors 902) and that cause the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

### ADDITIONAL CONSIDERATIONS

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Any feature mentioned in one claim category, e.g. method, can be claimed in another claim category, e.g. computer program product, system, storage medium, as well. The dependencies or references back in the attached claims are chosen for formal reasons only. However, any subject matter resulting from a deliberate reference back to any previous claims (in particular multiple dependencies) can be claimed as well, so that any combination of claims and the features thereof is disclosed and can be claimed regardless of the dependencies chosen in the attached claims. The subject matter may include not only the combinations of features as set out in the disclosed embodiments but also any other combination of features from different embodiments. Various features mentioned in the different embodiments can be combined with explicit mentioning of such combination or arrangement in an example embodiment or without any explicit mentioning. Furthermore, any of the embodiments and features described or depicted herein may be claimed in a separate claim and/or in any combination with any embodiment or feature described or depicted herein or with any of the features.

Some portions of this description describe the embodiments in terms of algorithms and symbolic representations of operations on information. These operations and algorithmic descriptions, while described functionally, computationally, or logically, are understood to be implemented by computer programs or equivalent electrical circuits, microcode, or the like. Furthermore, it has also proven convenient at times, to refer to these arrangements of operations as engines, without loss of generality. The described operations and their associated engines may be embodied in software, firmware, hardware, or any combinations thereof.

Any of the steps, operations, or processes described herein may be performed or implemented with one or more hardware or software engines, alone or in combination with other devices. In some embodiments, a software engine is implemented with a computer program product comprising a computer-readable medium containing computer program code, which can be executed by a computer processor for performing any or all of the steps, operations, or processes described. The term “steps” does not mandate or imply a particular order. For example, while this disclosure may describe a process that includes multiple steps sequentially with arrows present in a flowchart, the steps in the process do not need to be performed in the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights.

The following applications are incorporated by reference in their entirety for all purposes: (1) U.S. Pat. No. 10,679,729, entitled “Haplotype Phasing Models,” granted on Jun. 9, 2020, (2) U.S. Pat. No. 10,223,498, entitled “Discovering Population Structure from Patterns of Identity-By-Descent,” granted on Mar. 5, 2019, (3) U.S. Pat. No. 10,720,229, entitled “Reducing Error in Predicted Genetic Relationships,” granted on Jul. 21, 2020, (4) U.S. Pat. No. 10,558,930, entitled “Local Genetic Ethnicity Determination System,” granted on Feb. 11, 2020, (5) U.S. Pat. No. 10,114,922, entitled “Identifying Ancestral Relationships Using a Continuous Stream of Input,” granted on Oct. 30, 2018, (6) U.S. Pat. No. 11,429,615, entitled “Linking Individual Datasets to a Database,” granted on Aug. 30, 2022, (7) U.S. Pat. No. 10,692,587, entitled “Global Ancestry Determination System,” granted on Jun. 23, 2020, and (8) U.S. Patent Application Publication No. US 2021/0034647, entitled “Clustering of Matched Segments to Determine Linkage of Dataset in a Database,” published on Feb. 4, 2021.

What is claimed is:

1. A computer-implemented method, comprising:
scanning through a named-entity data store to identify a plurality of candidate named-entity data instances, wherein at least a majority of the candidate named-entity data instances correspond to named entities that are each associated with a data tree;
identifying, for each candidate named-entity data instance associated with a corresponding data tree, one or more upper-level nodes in the corresponding data tree where the named entity is represented as a node, wherein an upper-level nodes is positioned higher than the node representing the named entity;
determining, for each candidate named-entity data instance associated with the corresponding data tree, geographical location tags of the one or more upper-level nodes;
determining, based on the geographical location tags, the candidate named-entity data instance is a named-entity data instance typically associated with a geographical location;
identifying a plurality of named-entity data instances that are typically associated with the geographical location;
aggregating data characteristics of the plurality of named-entity data instances that are typically associated with the geographical location; and
causing to display an aggregated characteristics associated with the geographical location based on aggregating the data characteristics of the plurality of named-entity data instances.

2. The computer-implemented method of claim 1, wherein the one or more upper-level nodes in the corresponding data tree of a particular candidate named-entity data instance are terminal nodes.

3. The computer-implemented method of claim 1, wherein the one or more upper-level nodes in the corresponding data tree of a particular candidate named-entity data instance separates from the named entity for at least two levels in the data tree.

4. The computer-implemented method of claim 3, wherein determining a particular candidate named-entity data instance is a named-entity data instance typically associated with the geographical location comprises:
determining the geographical location tags of each of the one or more upper-level nodes;
determining that the geographical location tags all correspond to a particular geographical location; and
determining that the particular candidate named-entity data instance is typically associated with the particular geographical location.

5. The computer-implemented method of claim 1, further comprising:
adding the plurality of named-entity data instances that are typically associated with the geographical location as a reference panel of the geographical location.

6. The computer-implemented method of claim 1, wherein the data characteristics of the plurality of named-entity data instances comprise sequence compositions of the named-entity data instances.

7. The computer-implemented method of claim 1, wherein displaying the aggregated characteristics associated with the geographical location comprises displaying a distribution of one or more aggregated characteristics.

8. The computer-implemented method of claim 1, wherein the data characteristic of each of the plurality of named-entity data instances are determined based on:
inputting a sequence in the named-entity data instance to a hidden Markov model; and
generating a composition of the sequence using the hidden Markov model, wherein the composition of the sequence is the data characteristic.

9. A system, comprising:
a computing server comprising memory and one or more processors, the memory configured to store code comprising instructions, wherein the instructions, when executed by the one or more processors to perform steps comprising:
scanning through a named-entity data store to identify a plurality of candidate named-entity data instances, wherein at least a majority of the candidate named-entity data instances correspond to named entities that are each associated with a data tree;
identifying, for each candidate named-entity data instance associated with a corresponding data tree, one or more upper-level nodes in the corresponding data tree where the named entity is represented as a node, wherein an upper-level nodes is positioned higher than the node representing the named entity;
determining, for each candidate named-entity data instance associated with the corresponding data tree, geographical location tags of the one or more upper-level nodes;
determining, based on the geographical location tags, the candidate named-entity data instance is a named-entity data instance typically associated with a geographical location;
identifying a plurality of named-entity data instances that are typically associated with the geographical location; and
aggregating data characteristics of the plurality of named-entity data instances that are typically associated with the geographical location;
a graphical user interface in communication with the computing server, the graphical user interface configured to display an aggregated characteristic associated with the geographical location based on aggregating the data characteristic of the plurality of named-entity data instances.

10. The system of claim 9, wherein the one or more upper-level nodes in the corresponding data tree of a particular candidate named-entity data instance are terminal nodes.

11. The system of claim 9, wherein the one or more upper-level nodes in the corresponding data tree of a particular candidate named-entity data instance separates from the named entity for at least two levels in the data tree.

12. The system of claim 11, wherein determining a particular candidate named-entity data instance is a named-entity data instance typically associated with the geographical location comprises:
determining the geographical location tags of each of the one or more upper-level nodes;
determining that the geographical location tags all correspond to a particular geographical location; and
determining that the particular candidate named-entity data instance is typically associated with the particular geographical location.

13. The system of claim 9, wherein the steps further comprises:
adding the plurality of named-entity data instances that are typically associated with the geographical location as a reference panel of the geographical location.

14. The system of claim 9, wherein the data characteristic of the plurality of named-entity data instances comprise sequence compositions of the named-entity data instances.

15. The system of claim 9, wherein displaying the aggregated characteristic associated with the geographical location comprises displaying a distribution of one or more aggregated characteristic.

16. The system of claim 9, wherein the data characteristic of each of the plurality of named-entity data instances are determined based on:
inputting a sequence in the named-entity data instance to a hidden Markov model; and
generating a composition of the sequence using the hidden Markov model, wherein the composition of the sequence is the data characteristic.

17. A non-transitory computer readable medium configured to store code comprising instructions, wherein the instructions, when executed by one or more processors to perform steps comprising:
scanning through a named-entity data store to identify a plurality of candidate named-entity data instances, wherein at least a majority of the candidate named-entity data instances correspond to named entities that are each associated with a data tree;
identifying, for each candidate named-entity data instance associated with a corresponding data tree, one or more upper-level nodes in the corresponding data tree where the named entity is represented as a node, wherein an upper-level nodes is positioned higher than the node representing the named entity;
determining, for each candidate named-entity data instance associated with the corresponding data tree, geographical location tags of the one or more upper-level nodes;
determining, based on the geographical location tags, the candidate named-entity data instance is a named-entity data instance typically associated with a geographical location;
identifying a plurality of named-entity data instances that are typically associated with the geographical location;
aggregating data characteristic of the plurality of named-entity data instances that are typically associated with the geographical location; and
causing to display an aggregated characteristic associated with the geographical location based on aggregating the data characteristic of the plurality of named-entity data instances.

18. The non-transitory computer readable medium of claim 19, wherein determining a particular candidate named-entity data instance is a named-entity data instance typically associated with the geographical location comprises:
determining the geographical location tags of each of the one or more upper-level nodes;
determining that the geographical location tags all correspond to a particular geographical location; and
determining that the particular candidate named-entity data instance is typically associated with the particular geographical location.

19. The non-transitory computer readable medium of claim 17, wherein the steps further comprises:
adding the plurality of named-entity data instances that are typically associated with the geographical location as a reference panel of the geographical location.

20. The non-transitory computer readable medium of claim 17, wherein the data characteristic of each of the plurality of named-entity data instances are determined based on:
inputting a sequence in the named-entity data instance to a hidden Markov model; and
generating a composition of the sequence using the hidden Markov model, wherein the composition of the sequence is the data characteristic.
